(19) United States
(12) Patent Application Publication
(10) Pub. No.: US 2026/0003404 A1
(43) Pub. Date: Jan. 1, 2026

(54) ELECTRONIC DEVICE INCLUDING WATERPROOFING STRUCTURE

(71) Applicant: Samsung Electronics Co., Ltd., Suwon-si (KR)

(72) Inventors: Donghee KIM, Suwon-si (KR); Yonggwan KIM, Suwon-si (KR); Seungchul BAEK, Suwon-si (KR)

(21) Appl. No.: 19/252,418

(22) Filed: Jun. 27, 2025

Related U.S. Application Data
(63) Continuation of application No. PCT/KR2025/007859, filed on Jun. 10, 2025.

(30) Foreign Application Priority Data
Jul. 1, 2024 (KR) 10-2024-0086253
Aug. 7, 2024 (KR) 10-2024-0105298

(51) Int. Cl. G06F 1/16; H04R 1/02

(52) U.S. Cl. CPC G06F 1/1656; G06F 1/1688; H04R 1/023; H04R 2499/11; H04R 2499/15

(57) ABSTRACT

An electronic device may include: a housing including a side wall and a speaker hole formed in the side wall, a speaker disposed inside the housing and configured to output a sound through the speaker hole, and a waterproofing structure disposed between an inner surface of the side wall and the speaker. The waterproofing structure may include a rigid body disposed between the speaker and the inner surface and including a plate, a first opening formed in the plate, a first rib protruding from the plate, and a second rib protruding from the plate and spaced apart from the first rib, a first adhesive member disposed between the rigid body and the inner surface and including an adhesive material, an elastic member disposed between the rigid body and the speaker and including an elastic material, and a mesh at least partially accommodated in the elastic member. The speaker hole may include a first portion and a second portion facing the first portion. A first distance between the first rib and the second rib may be greater than a second distance between the first portion and the second portion.

### CROSS-REFERENCE TO RELATED APPLICATIONS

This application is a continuation of International Application No. PCT/KR2025/007859 designating the United States, filed on Jun. 10, 2025, in the Korean Intellectual Property Receiving Office and claiming priority to Korean Patent Application Nos. 10-2024-0086253, filed on Jul. 1, 2024, and 10-2024-0105298, filed on Aug. 7, 2024, in the Korean Intellectual Property Office, the disclosures of each of which are incorporated by reference herein in their entireties.

### BACKGROUND

### Field

The disclosure relates to an electronic device. For example, an embodiment relate to an electronic device including a waterproofing structure.

### Description of Related Art

Due to the remarkable development of information communication technology and semiconductor technology, the distribution and use of various electronic devices are rapidly increasing. Electronic devices have been developed such that users are capable of communicating with each other while carrying the electronic devices.

The term “electronic device” may refer to a device that performs a specific function based on an installed program, such as a home appliance, an electronic scheduler, a portable multimedia player, a mobile communication terminal, a tablet PC, a video/audio device, a desktop/laptop PC, or a vehicle navigation system. For example, these electronic devices may output stored information as sound or images. As the degree of integration of electronic devices increases and ultra-high-speed and high-capacity wireless communication become more widespread, a single electronic device, such as a mobile communication terminal, may be equipped with various functions. For example, not only communication functions but also entertainment functions such as gaming, multimedia functions such as music and video playback, communication and security functions such as mobile banking, or schedule management and electronic wallet functions, are being integrated into a single electronic device. These electronic devices are being miniaturized to be conveniently carried by users.

The above-described information may be provided as related art for the purpose of helping to understand the disclosure. No assertion or determination is made as to whether any of the foregoing may be applied as prior art with respect to the disclosure.

### SUMMARY

According to an example embodiment of the disclosure, an electronic device may include: a housing including a side wall and a speaker hole formed in the side wall, a speaker disposed inside the housing and configured to output a sound through the speaker hole, and a waterproofing structure disposed between an inner surface of the side wall and the speaker. The waterproofing structure may include a rigid body disposed between the speaker and the inner surface and including a plate, a first opening formed in the plate, a first rib protruding from the plate, and a second rib protruding from the plate and spaced apart from the first rib, a first adhesive member disposed between the rigid body and the inner surface and including an adhesive material, an elastic member disposed between the rigid body and the speaker and including an elastic material, and a mesh at least partially accommodated in the elastic member. The speaker hole may include a first portion and a second portion facing the first portion. A first distance between the first rib and the second rib may be greater than a second distance between the first portion and the second portion.

According to an example embodiment of the disclosure, an electronic device may include: a housing including a side wall and at least one speaker hole formed in the side wall, a speaker disposed inside the housing and configured to output a sound through the speaker hole, and a waterproofing structure disposed between an inner surface of the side wall and the speaker. The waterproofing structure may include a rigid body disposed between the speaker and the inner surface and including a plate and at least one first opening formed in the plate, a first adhesive member disposed between the rigid body and the inner surface and including an adhesive material, an elastic member disposed between the rigid body and the speaker and including an elastic material, and a mesh at least partially accommodated in the elastic member.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of illustrating an example electronic device in a network environment according to an embodiment;

FIG. 2 is a front perspective view of an example electronic device according to an embodiment;

FIG. 3 is a rear perspective view of the electronic device according to an embodiment;

FIG. 4 is a front exploded perspective view of the electronic device according to an embodiment;

FIG. 5 is a rear exploded perspective view of the electronic device according to an embodiment;

FIG. 6 is a partial perspective view of a speaker and a waterproofing structure according to an embodiment;

FIG. 7 is an exploded perspective view of the waterproofing structure according to an embodiment;

FIG. 8 is a cross-sectional view of the waterproofing structure according to in an assembled state according to an embodiment;

FIG. 9 is a cross-sectional view of an electronic device, taken along line A-A′ in FIG. 2 according to an embodiment;

FIGS. 10, 11, 12, 13, 14, 15, and 16 are diagrams illustrating various views illustrating a manufacturing process of a waterproofing structure according to an embodiment;

FIGS. 17, 18, and 19 are perspective views each illustrating a rigid body according to an embodiment;

FIG. 20 is a diagram illustrating a plan view of a speaker hole according to an embodiment;

FIG. 21 is a diagram illustrating a plan view of a speaker hole according to an embodiment;

FIG. 22 is an exploded perspective view of the waterproofing structure according to an embodiment;

FIG. 23 is a cross-sectional view of the waterproofing structure in an assembled state according to an embodiment;

FIG. 24 is a cross-sectional view of the waterproofing structure in an assembled state according to an embodiment;

FIG. 25 is a cross-sectional view of an electronic device according to an embodiment;

FIG. 26 is a cross-sectional view of an electronic device according to an embodiment;

FIG. 27 is a cross-sectional view of an electronic device according to an embodiment;

FIG. 28 is a cross-sectional view of an electronic device according to an embodiment;

FIG. 29 is a cross-sectional view of an electronic device according to an embodiment;

FIG. 30 is a cross-sectional view of an electronic device according to an embodiment;

FIG. 31 is a cross-sectional view of an electronic device according to an embodiment; and

FIG. 32 is a cross-sectional view of an electronic device according to an embodiment.

### DETAILED DESCRIPTION

Hereinafter, various example embodiments of the disclosure will be described in greater detail with reference to the drawings. However, the disclosure may be implemented in many different forms, and is not limited to the example embodiments described herein. In connection with a description made with reference to the drawings, the same or similar reference numerals may be used for the same or similar elements. In addition, in the drawings and related descriptions, descriptions of well-known functions and configurations may be omitted for clarity and brevity.

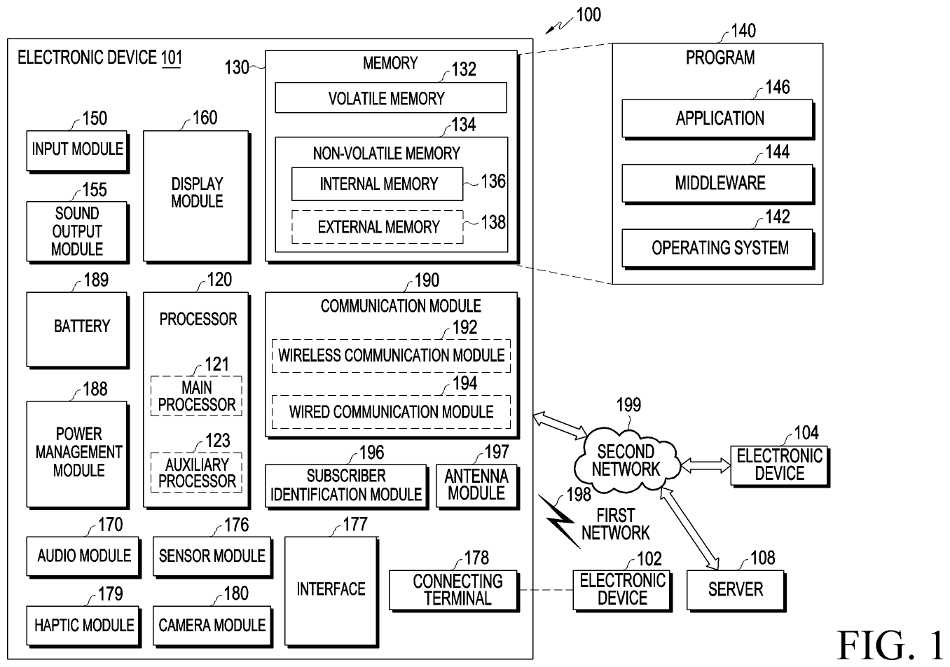

FIG. 1 is a block diagram illustrating an example electronic device 101 in a network environment 100 according to an embodiment.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one of the components (e.g., the connecting terminal 178) may be omitted from the electronic device 101, or one or more other components may be added in the electronic device 101. In an embodiment, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (cMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to an embodiment may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that an embodiment of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with an embodiment of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to an embodiment, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

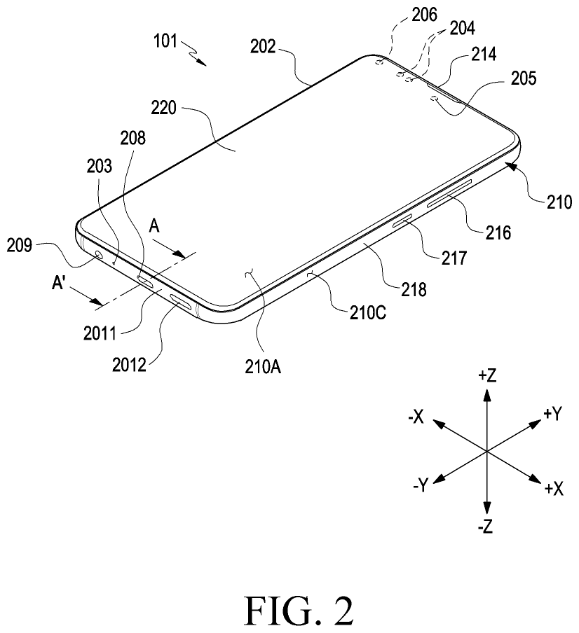

FIG. 2 is a front perspective view of an electronic device according to an embodiment.

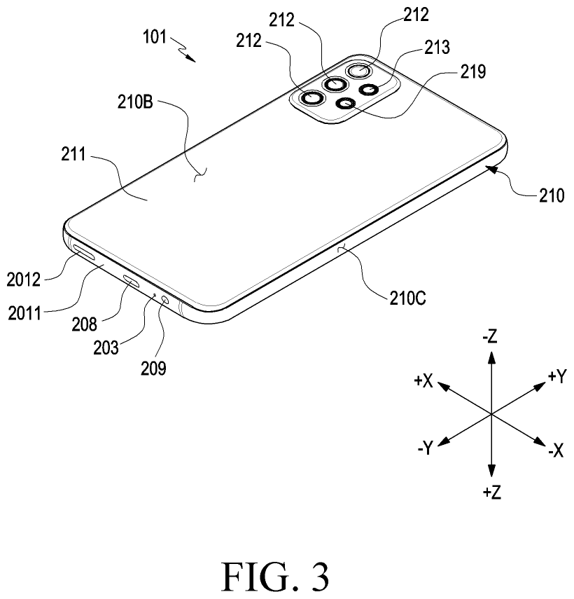

FIG. 3 is a rear perspective view of the electronic device according to an embodiment.

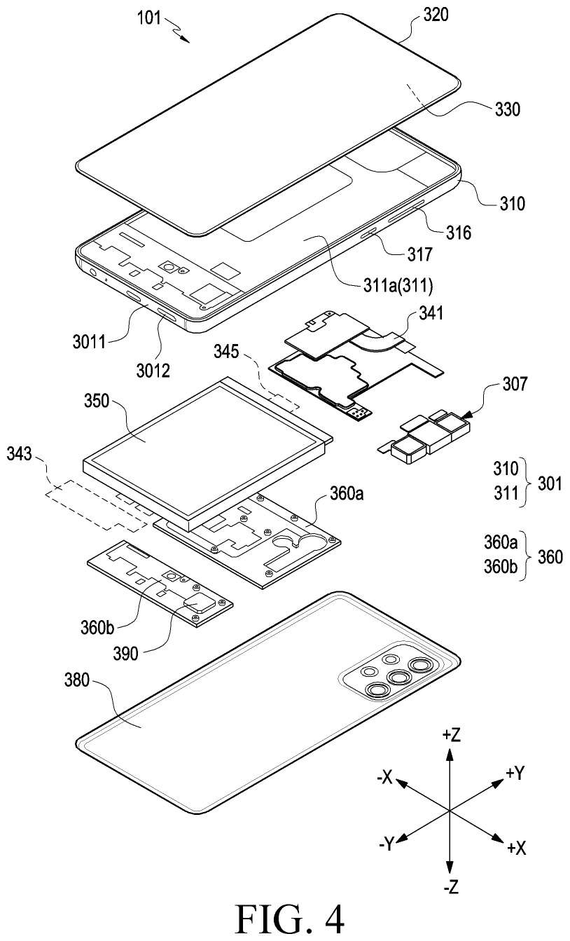

The example embodiments of FIGS. 2 and 3 may be combined with the example embodiment of FIG. 1 or the example embodiments of FIGS. 4 to 32.

Referring to FIGS. 2 and 3, an electronic device 101 according to an embodiment (e.g., the electronic device 101 of FIG. 1) may include a housing 210 that includes a first surface (or front surface) 210A, a second surface (or rear surface) 210B, and a side surface 210C surrounding a space between the first surface 210A and the second surface 210B. In an embodiment, the housing 210 may refer to a structure that forms a portion of the first surface 210A of FIG. 2, and the second surface 210B and the side surface 210C of FIG. 3. According to an embodiment, at least a portion of the first surface 210A may be made of a substantially transparent front surface plate 202 (e.g., a glass plate or a polymer plate including various coating layers). The second surface 210B may be made of a substantially opaque rear surface plate 211. The rear surface plate 211 may be made of, for example, coated or colored glass, ceramic, polymer, metal (e.g., aluminum, stainless steel (STS), or magnesium), or a combination of two or more of these materials. The side surface 210C may be defined by the side surface structure (or a “side surface bezel structure”) 218 coupled to the front surface plate 202 and the rear surface plate 211 and including metal and/or polymer. In an embodiment, the rear surface plate 211 and the side surface structure 218 may be integrated with each other and may include the same material (e.g., a metal material such as aluminum).

Although not illustrated, the front surface plate 202 may include one or more areas that are curved and extend seamlessly from at least a portion of an edge toward the rear surface plate 211. In an embodiment, the front surface plate 202 (or the rear surface plate 211) may include only one of the areas bent and extending toward the rear surface plate 211 (or the front surface plate 202), at one side edge of the first surface 210A. According to an embodiment, the front surface plate 202 or the rear surface plate 211 may be substantially flat in shape. For example, the front surface plate 202 or the rear surface plate 211 may not include a curved extension area. When the front surface plate 202 or the rear surface plate 211 includes a curved extension area, the thickness of the electronic device 101 at the portion where the curved extension area is included may be smaller than the thickness at other portions.

According to an embodiment, the electronic device 101 may include at least one of a display 220, audio modules 203, 207, and 214, sensor modules 204 and 219, camera modules 205, 212, and 213, key input devices 216 and 217, light-emitting elements 206, and connector holes 208 and 209. In an embodiment, in the electronic device 101, at least one of the components (e.g., the key input devices 216 and 217 or the light-emitting element 206) may be omitted, or other components may be additionally included.

The display 220 may be visible through a substantial portion of, for example, the front surface plate 202. In an embodiment, at least a portion of the display 220 may be visible through the front surface plate 202 forming the first surface 210A or through a portion of the side surface 210C. In an embodiment, the edge of the display 220 may be formed to be substantially the same as the shape of the periphery of the front surface plate 202 adjacent thereto. In an embodiment (not illustrated), the distance between the periphery of the display 220 and the periphery of the front surface plate 202 may be substantially constant in order to enlarge the visible area of the display 220.

In an embodiment, recesses or openings may be provided in some portions of the screen display area of the display 220, and the electronic device 101 may include one or more of the audio module 214, the sensor module 204, the camera module 205, and the light-emitting elements 206 aligned with the recesses or the openings. In an embodiment, the rear surface of the screen display area of the display 220 may include at least one of the audio module 214, the sensor modules 204, the camera modules 205, a fingerprint sensor, and the light-emitting elements 206. In an embodiment, the display 220 may be coupled to or arranged adjacent to a touch-sensing circuit, a pressure sensor that is capable of measuring touch intensity (pressure), and/or a digitizer that detects a magnetic field-type stylus pen.

According to an embodiment, the camera module 205 may be configured to capture the front of the display 220 through a camera opening formed in the display 220. The camera module 205 may be covered by the front surface plate 202. The camera module 205 may not be visually exposed through the display 220 and may include a hidden under-display camera (UDC). The under-display camera may be configured to capture external objects through the camera opening of the display 220.

The audio modules 203, 207, and 214 may include a microphone hole 203 and speaker holes 214 and 2012. A microphone for acquiring external sound through the microphone hole 203 may be disposed inside the housing 210, and in an embodiment, multiple microphones may be disposed to detect the direction of sound. The speaker holes 214 and 2012 may include a receiver hole 214 for calls and an external speaker hole 2012. In an embodiment, the speaker holes 214 and 2012 and the microphone hole 203 may be implemented as a single hole, or a speaker (e.g., a piezo speaker) may be included without the speaker holes 214 and 2012.

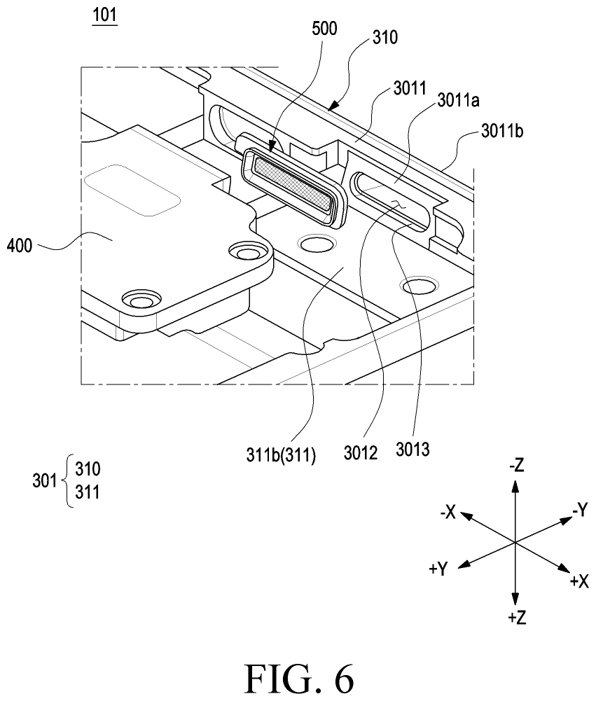

According to an embodiment, the external speaker hole 2012 may form a passage for transmitting or outputting sound generated from a speaker disposed inside the housing 210 (e.g., the speaker 400 of FIG. 6) to the outside of the electronic device 101.

According to an embodiment, the external speaker hole 2012 may be formed in a bottom side wall 2011 of the electronic device 101 that forms at least a portion of the side surface 210C (e.g., the side wall oriented in the −Y direction in FIGS. 2 and 3), but is not limited thereto. Hereinafter, for convenience of description, the bottom side wall 2011 may be defined and/or referred to as the side wall 2011. According to the illustrated embodiment, the external speaker hole 2012 is illustrated as being formed in the side wall 2011 oriented in the −Y direction, but is not limited thereto and may be formed in another side wall oriented in a different direction. The side wall 2011 may form at least a portion of the edge of the electronic device 101.

The sensor modules 204 and 219 may generate electrical signals or data values corresponding to an internal operating state or an external environmental state of the electronic device 101. The sensor modules 204 and 219 may include, for example, a first sensor module 204 (e.g., a proximity sensor) and/or a second sensor module (e.g., a fingerprint sensor) disposed on the first surface 210A of the housing 210, and/or a third sensor module 219 and/or a fourth sensor module (e.g., a fingerprint sensor) disposed on the second surface 210B of the housing 210. The fingerprint sensor may be disposed not only on the first surface 210A (e.g., the display 220) of the housing 210, but also on the second surface 210B or the side surface 210C. The electronic device 101 may further include at least one of, for example, a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor.

The camera modules 205, 212, and 213 may include a first camera device 205 disposed on the first surface 210A of the electronic device 101, and a second camera device 212 and/or a flash 213 disposed on the second surface 210B. The camera devices 205 and 212 may include one or more lenses, an image sensor, and/or an image signal processor. The flash 213 may include, for example, a light-emitting diode or a xenon lamp. In an embodiment, two or more lenses (e.g., an infrared camera lens, a wide-angle lens, and a telephoto lens) and image sensors may be disposed on one surface of the electronic device 101. In an embodiment, the flash 213 may emit infrared rays, and the infrared light emitted by the flash 213 and reflected by a subject may be received through the third sensor module 219. The electronic device 101 or the processor of the electronic device 101 may detect depth information of the subject based on a time point when infrared rays are received from the third sensor module 219.

The key input devices 216 and 217 may be disposed on one surface of the housing 210. For example, the key input devices 216 and 217 may be disposed on the side surface 210C of the housing 210. In an embodiment, the electronic device 101 may not include some or all of the aforementioned key input devices 216 and 217, and the key input device that is not included may be implemented in another form, such as a soft key on the display 220. In an embodiment, the key input devices 216 and 217 may include a sensor module disposed on the second surface 210B of the housing 210.

According to an embodiment, the key input devices 216 and 217 may be defined and/or referred to as a side key, a key input module, or a button assembly.

According to an embodiment, the key input devices 216 and 217 may include a volume key 216 or a power key 217. The volume key 216 may be a key capable of adjusting the intensity of an audio signal output from the electronic device 101. The volume key 216 may have an elongated shape when viewed from a side of the electronic device 101 (e.g., when viewed from the +X direction toward the −X direction in FIGS. 2 and 3). As the volume key 216 is provided in an elongated shape, a key input for volume up may be possible on one side of the volume key 216, and a key input for volume down may be possible on the other side of the volume key 216. For example, when viewed from a side of the electronic device 101, the volume key 216 may visually appear as a single member, but the volume key 216 may provide two key input points. The volume key 216 may be configured to adjust the intensity of an audio signal, but is not limited thereto and may provide other key input functions such as scroll up-down adjustment, text size adjustment, or other functions.

According to an embodiment, the power key 217 may be spaced apart from the volume key 216. The power key 217 may be configured to adjust the on-off operation of the electronic device 101 or to adjust a standby mode and an activation mode of the electronic device 101.

The light-emitting element 206 may be disposed, for example, on the first surface 210A of the housing 210. The light-emitting element 206 may provide, for example, the state information of the electronic device 101 in an optical form. In an embodiment, the light-emitting element 206 may provide, for example, a light source that is linked with the operation of the camera module 205. The light-emitting element 206 may include, for example, a light-emitting diode (LED), an infrared (IR) LED, and a xenon lamp.

The connector holes 208 and 209 may include a first connector hole 208 capable of accommodating a connector (e.g., a USB connector) configured to transmit/receive power and/or data to/from an external electronic device, and/or a second connector hole (e.g., an earphone jack) 209 capable of accommodating a connector configured to transmit/receive an audio signal to/from an external electronic device.

FIG. 4 is a front exploded perspective view of the electronic device according to an embodiment.

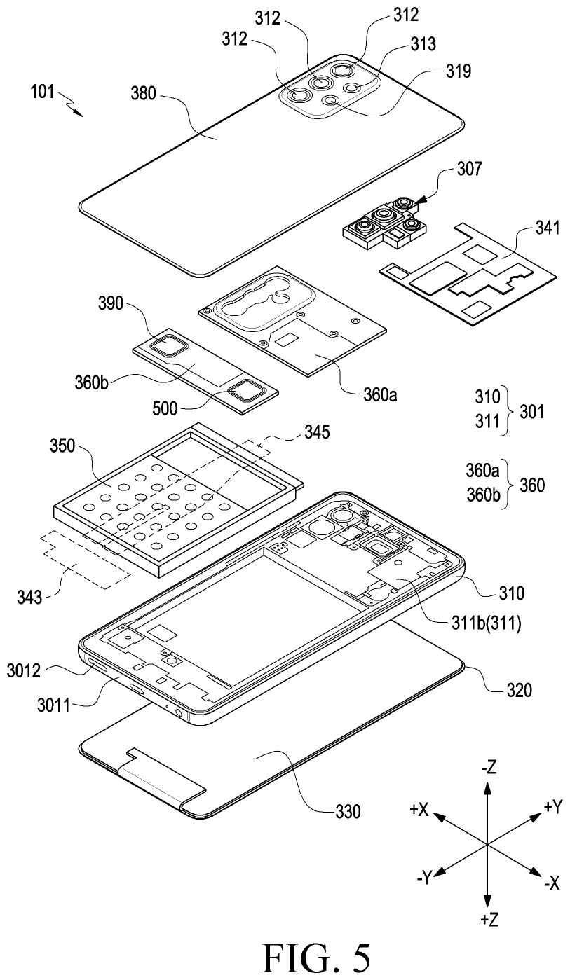

FIG. 5 is a rear exploded perspective view of the electronic device according to an embodiment.

The example embodiments of FIGS. 4 and 5 may be combined with the example embodiments of FIGS. 1 to 3 or the example embodiments of FIGS. 6 to 32.

Referring to FIGS. 4 and 5, the electronic device 101 (e.g., the electronic device 101 in FIG. 1 or the electronic device 101 in FIGS. 2 and 3) may include a side surface structure 310, a first support member 311 (e.g., a bracket), a front surface plate 320 (e.g., the front surface plate 202 in FIG. 2), a display 330 (e.g., the display 220 in FIG. 2), one or more printed circuit boards (or substrate assemblies) 341 and 343, a battery 350, a second support member 360 (e.g., a rear case), an antenna, a camera assembly 307, and a rear surface plate 380 (e.g., the rear surface plate 211 in FIG. 2). When the electronic device 101 includes multiple printed circuit boards 341 and 343, the electronic device 101 may electrically connect different printed circuit boards by including at least one flexible connection member 345. For example, the printed circuit boards 341 and 343 may include a first circuit board 341 disposed above the battery 350 (e.g., in the +Y-axis direction) and a second circuit board 343 disposed below the battery 350 (e.g., in the −Y-axis direction), and the flexible connection member 345 may electrically connect the first circuit board 341 and the second circuit board 343.

In an embodiment, in the electronic device 101, at least one of the components (e.g., the first support member 311 or the second support member 360) may be omitted, or other components may be additionally included. At least one of the components of the electronic device 101 may be the same as or similar to at least one of the components of the electronic device 101 of FIGS. 1 to 3, and a redundant description thereof is omitted below.

According to an embodiment, the electronic device 101 may include a housing 301 (e.g., the housing 210 of FIGS. 2 and 3).

According to an embodiment, the housing 301 may include a first support member 311 and a side surface structure 311 (e.g., the side surface structure 218 or the side surface 210C of FIGS. 2 and 3).

According to an embodiment, the housing 301 may include a side wall 3011 (e.g., the side wall oriented in the −Y direction in FIGS. 4 and 5) that includes a speaker hole 3012 (e.g., the external speaker hole 2012 of FIGS. 2 and 3).

According to an embodiment, at least a portion of the first support member 311 may be provided in a planar shape. In an embodiment, the first support member 311 may be disposed inside the electronic device 101 to be connected to the side surface structure 310 or may be integrated with the side surface structure 310. The first support member 311 may be made of, for example, a metal material and/or a non-metal (e.g., polymer) material. When the first support member 311 is at least partially made of a metal material, a portion of the side surface structure 310 or the first support member 311 may serve as an antenna.

According to an embodiment, the first support member 311 may include a front side 311a and a rear side 311b opposite to the front side 311a. The front side 311a may be defined and/or referred to as a first surface 311a or a front surface 311a. The rear side 311b may be defined and/or referred to as a second surface 311b or a rear surface 311b.

According to an embodiment, the front surface 311a may face the display 330. The rear surface 311b may face the rear surface plate 380.

According to an embodiment, the display 330 may be coupled to the front surface 311a of the first support member 311, and the printed circuit boards 341 and 343 may be coupled to the rear surface 311b of the first support member 311. The printed circuit boards 341 and 343 may be mounted with a processor, memory, and/or an interface. The processor may include, for example, one or more of a central processing unit, an application processor, a graphics processing unit, an image signal processor, a sensor hub processor, or a communication processor.

According to an embodiment, the first support member 311 and the side surface structure 310 may be combined to be referred to as a front case or a housing 301. According to an embodiment, the housing 301 may be generally understood as a structure for accommodating, protecting, or arranging printed circuit boards 341 and 343, or a battery 350. In an embodiment, it may be understood that the housing 301 includes structures capable of being visually or tactfully recognized by a user in the exterior of the electronic device 101, such as the side surface structure 310, the front surface plate 320, and/or the rear surface plate 380. In an embodiment, the “front surface or rear surface of the housing 301” may refer to the first surface 210A in FIG. 2 or the second surface 210B in FIG. 3. In an embodiment, the first support member 311 may be disposed between the front surface plate 320 (e.g., the first surface 210A in FIG. 2) and the rear surface plate 380 (e.g., the second surface 210B in FIG. 3), and may serve as a structure on which electrical/electronic components, such as the printed circuit boards 341 and 343 or the camera assembly 307, are disposed.

According to an embodiment, the memory may include, for example, volatile memory (e.g., the volatile memory 132 in FIG. 1) or nonvolatile memory (e.g., the nonvolatile memory 134 in FIG. 1).

According to an embodiment, the interface may include, for example, a high-definition multimedia interface (HDMI), a universal serial bus (USB) interface, an SD card interface, and/or an audio interface. The interface may electrically or physically connect, for example, the electronic device 101 to an external electronic device, and may include a USB connector, an SD card/a multimedia card (MMC) connector, or an audio connector.

According to an embodiment, the second support member 360 may include, for example, an upper support member 360a and a lower support member 360b. In an embodiment, the upper support member 360a may be disposed to enclose a printed circuit board 341 or 343 (e.g., the first circuit board 340a) together with a portion of the first support member 311. For example, the upper support member 360a of the second support member 360 may be disposed to face the first support member 311 with the first circuit board 341 interposed therebetween. In an embodiment, the lower support member 360b of the second support member 360 may be disposed to face the first support member 311 with the second circuit board 343 interposed therebetween. Circuit devices implemented in the form of integrated circuit chips (e.g., a processor, a communication module, or memory) or various electrical/electronic components may be disposed on the circuit boards 341 and 343. According to an embodiment, the circuit boards 341 and 343 may be provided with an electromagnetic shielding environment from the second support member 360. In an embodiment, the lower support member 360b may be used as a structure on which electric/electronic components such as a speaker module and an interface (e.g., a USB connector, an SD card/MMC connector, or an audio connector) may be disposed. In an embodiment, electrical/electronic components, such as a speaker module and an interface (e.g., a USB connector, an SD card/MMC connector, or an audio connector), may be disposed on an additional printed circuit board (not illustrated). For example, the lower support member 360b may be disposed to enclose the additional circuit board together with the other portion of the first support member 311. An interface disposed on the additional circuit board (not illustrated) or the lower support member 360b may be disposed to correspond to the audio module 207 or the connector holes 208 and 209 in FIG. 2.

According to an embodiment, the battery 350 is a device that supplies power to at least one component of the electronic device 101, and may include, for example, a non-rechargeable primary battery, a rechargeable secondary battery, or a fuel cell. At least a portion of the battery 350 may be disposed on substantially the same plane as, for example, the printed circuit boards 341 and 343. The battery 350 may be integrally disposed inside the electronic device 101 or may be detachably disposed on the electronic device 101.

Although not illustrated, the antenna may include a conductor pattern implemented on the surface of the second support member 360 through, for example, a laser direct structuring method. In an embodiment, the antenna may include a printed circuit pattern provided on the surface of a thin film, and the thin film-type antenna may be disposed between the rear surface plate 380 and the battery 350. The antenna may include, for example, a near-field communication (NFC) antenna, a wireless charging antenna, and/or a magnetic secure transmission (MST) antenna. The antenna may, for example, perform short-distance communication with an external device, or wirelessly transmit and receive power required for charging. In an embodiment, an antenna structure may be configured with a portion or a combination of the side surface structure 310 and/or the first support member 311.

According to an embodiment, the camera assembly 307 may include at least one camera module. Inside the electronic device 101, the camera assembly 307 (or at least one camera module) may receive at least some of light incident through optical holes or camera windows 312, 313, and 319. In an embodiment, the camera assembly 307 may be disposed on the first support member 311 at a position adjacent to the printed circuit boards 341 and 343. In an embodiment, the camera modules of the camera assembly 307 may be generally aligned with one of the camera windows 312, 313, and 319, and may be at least partially enclosed by the second support member 360 (e.g., the upper support member 360a).

According to an embodiment, the electronic device 101 may include a flexible connection member 345. The flexible connection member 345 may include a flexible flat cable (FFC), a flexible printed circuit board (FPCB), or a board-to-board (B2B) connector.

According to an embodiment, the flexible connection member 345 may be at least partially bendable. For example, the flexible connection member 345 may be configured to be at least partially folded or unfolded.

According to an embodiment, the flexible connection member 345 may electrically connect the first circuit board 341 (e.g., a main circuit board) and at least one electrical component. For example, one end of the flexible connection member 345 may be physically and/or electrically connected to at least a portion of the first circuit board 341. For example, the other end of the flexible connection member 345 may be physically and/or electrically connected to at least a portion of the at least one electrical component. The at least one electrical component may include, for example, the second circuit board 343 (e.g., a sub-circuit board). However, the at least one electrical component is not limited thereto and may include various electrical components (e.g., an antenna, a speaker, a battery, a display, or a sensor).

According to an embodiment, the flexible connection member 345 may be configured to transmit power or an electrical signal from the first circuit board 341 to at least one electrical component. The flexible connection member 345 may be configured to transmit power or an electrical signal from the at least one electrical component to the first circuit board 341. The electrical signal may include a control signal, a power signal, or a communication signal.

According to an embodiment, the electronic device 101 may include key input devices 316 and 317 (e.g., the key input devices 216 and 217 of FIG. 2). The key input devices 316 and 317 may include a volume key 316 (e.g., the volume key 216 of FIG. 2) or a power key (e.g., the power key 217 of FIG. 2).

According to an embodiment, the volume key 316 may be disposed on one surface of the housing 301. For example, the volume key 316 may be disposed on a portion of the side surface (lateral surface) of the housing 301 (e.g., the side surface structure 310 of FIG. 4), but is not limited thereto.

According to an embodiment, the volume key 316 may include a haptic module (e.g., the haptic module 179 of FIG. 1). The haptic module may include a piezo actuator. The piezo actuator may be configured to provide a mechanical stimulus (e.g., vibration or movement) that can be perceived by a user through tactile or kinesthetic sensation when the user presses or touches the volume key 316.

According to an embodiment, the volume key 316 may have an elongated shape when viewed from a side of the electronic device 101 (e.g., when viewed from the +X direction toward the −X direction in FIG. 4). The volume key 316 may be spaced apart from the power key 317.

According to an embodiment, the electronic device 101 may include a speaker 390 (e.g., the sound output module 155 or the audio module 170 of FIG. 1). According to an embodiment, the speaker 390 may be configured to output sound to the outside of the electronic device 101 through the speaker hole 3012 formed in the side wall 3011.

According to an embodiment, the speaker 390 may be configured to convert an electrical signal into sound and to output the sound to the outside of the electronic device 101. For example, the speaker 390 may include a diaphragm, a magnet, or a voice coil.

According to an embodiment, the sound generated from the speaker 390 may be output to the outside of the electronic device 101 through the speaker hole 3012 (e.g., the external speaker hole 3012 of FIG. 2).

According to an embodiment, the speaker 390 may include a speaker component or a speaker enclosure.

According to an embodiment, the speaker 390 may be disposed adjacent to an inner surface of the side wall 3011 (e.g., a surface facing the inside of the electronic device 101). The speaker 390 may be disposed on the rear surface 311b of the first support member 311.

FIG. 6 is a partial perspective view of a speaker and a waterproofing structure according to an embodiment.

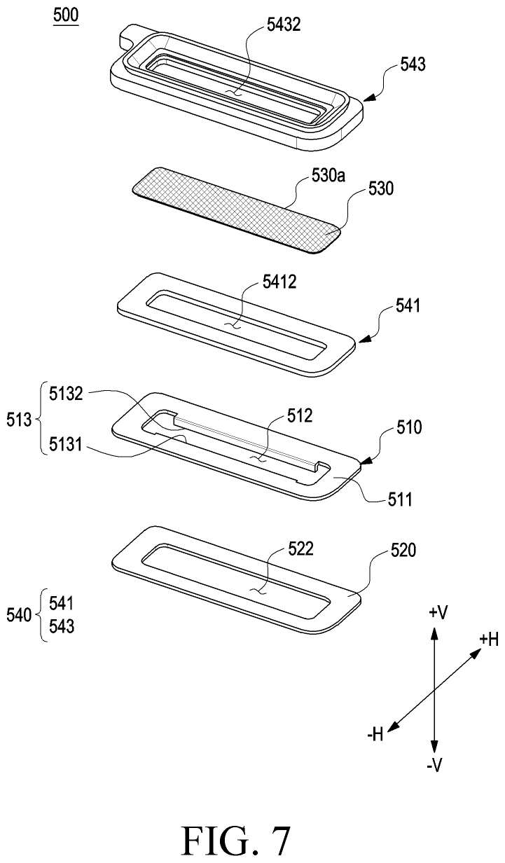

The example embodiment of FIG. 6 may be combined with the example embodiments of FIGS. 1 to 5 or the example embodiments of FIGS. 7 to 32.

The configurations of the example embodiment in FIG. 6 may be partially or entirely the same as the configurations of the example embodiments in FIGS. 1 to 5 or FIGS. 7 to 32.

Referring to FIG. 6, the electronic device 101 (e.g., the electronic device 101 of FIGS. 2 to 5) may include a housing 301 (e.g., the housing 301 of FIGS. 4 and 5).

According to an embodiment, the housing 301 may include a first support member 311 and a side surface structure 310. According to an embodiment, the side structure 310 may include a side wall 3011 (e.g., the side wall 2011 of FIGS. 2 and 3 or the side wall 3011 of FIGS. 4 and 5).

According to an embodiment, the side wall 3011 may include an outer surface 3011b facing the outside of the electronic device 101 and an inner surface 3011a facing the inner space of the electronic device 101. The inner surface 3011a may be defined as at least a portion of the entire inner surface of the side wall 3011 where the waterproofing structure 500 is seated, but is not limited thereto.

According to an embodiment, the housing 301 may include a speaker hole (e.g., the speaker hole 3012 of FIGS. 4 and 5) 3012 formed in the side wall 3011.

According to an embodiment, the speaker hole 3012 may be formed to penetrate from the inner surface 3011a to the outer surface 3011b. The speaker hole 3012 may form a passage for transmitting sound generated from the speaker 400 (e.g., the speaker 390 of FIGS. 4 and 5) to the outside of the electronic device 101.

According to an embodiment, when the inner surface 3011a is viewed, the speaker hole 3012 may have an elongated shape. For example, the speaker hole 3012 may be formed or extended in an elongated manner along the width direction of the electronic device 101 (e.g., the X-axis direction of FIG. 6).

According to an embodiment, the waterproofing structure 500 may be disposed between the speaker 400 and the inner surface 3011a.

According to an embodiment, the waterproofing structure 500 may be disposed between the inner surface 3011a and the speaker 400 and may be configured to block the inflow of external liquid into the inner space of the electronic device 101 through the space between the inner surface 3011a and the speaker 400. For example, the waterproofing structure 500 may seal the space between the inner surface 3011a and the speaker 400.

According to an embodiment, the waterproofing structure 500 may form a passage for transmitting sound generated from the speaker 400 to the speaker hole 3012.

According to an embodiment, the waterproofing structure 500 may include a mesh (e.g., the mesh 530 of FIG. 7) for blocking the inflow of external foreign substances into the speaker 400.

According to an embodiment, the speaker 400 may be disposed on the rear surface 311b of the first support member 311 (e.g., a surface oriented in the −Z direction in FIG. 6). At least a portion of the speaker 400 may be in close contact with the waterproofing structure 500. The speaker 400 may be aligned with the speaker hole 3012 and may be configured to output sound to the outside of the electronic device 101 through the speaker hole 3012.

According to an embodiment, the housing 301 may include a stepped portion 3013 formed to be recessed from the inner surface 3011a. The stepped portion 3013 may be formed along the periphery of the speaker hole 3012. For example, the stepped portion 3013 may be formed around the speaker hole 3012.

According to an embodiment, the stepped portion 3013 may be formed at the boundary between the inner surface 3011a and the speaker hole 3012.

According to an embodiment, a portion of the waterproofing structure 500 may be disposed in the stepped portion 3013, thereby restricting and/or reducing the slip of the waterproofing structure 500.

FIG. 7 is an exploded perspective view of the waterproofing structure according to an embodiment.

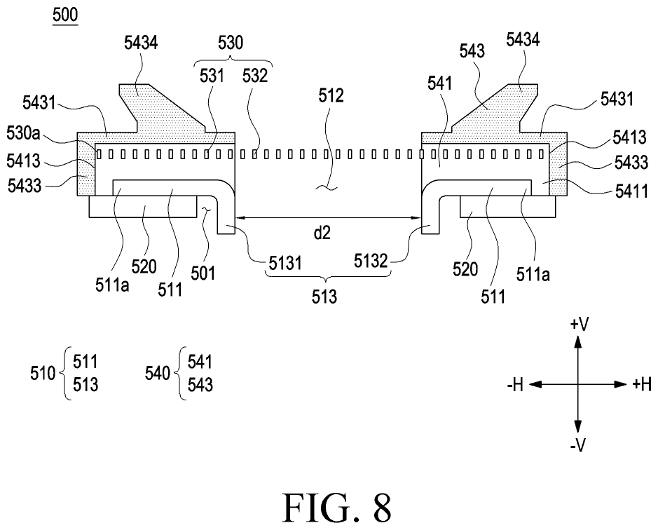

FIG. 8 is a cross-sectional view of the waterproofing structure according to in an assembled state according to an embodiment.

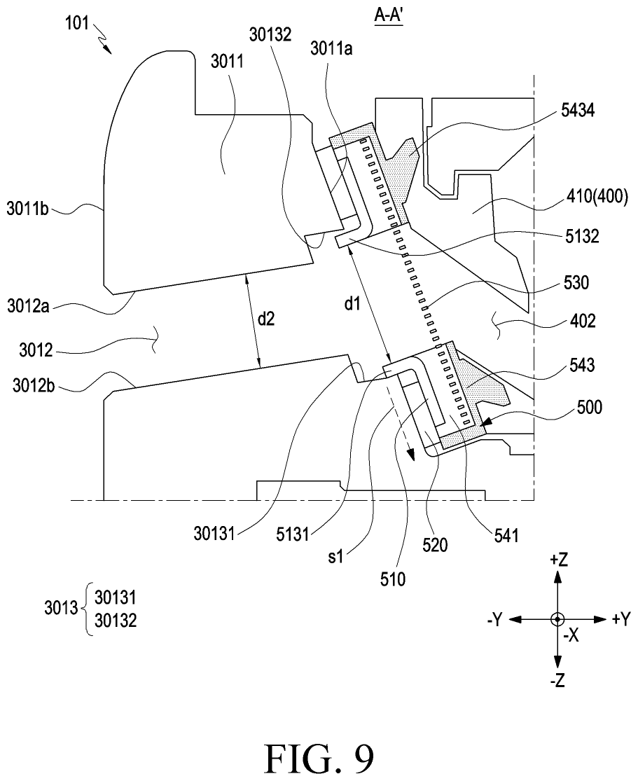

FIG. 9 is a cross-sectional view of an electronic device, taken along line A-A′ in FIG. 2 according to an embodiment.

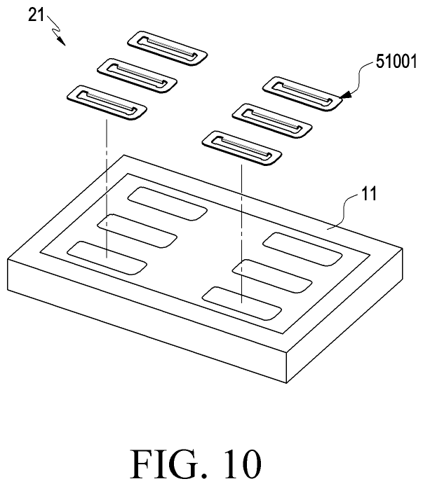

The example embodiments of FIGS. 7, 8 and 9 may be combined with the example embodiments of FIGS. 1 to 6 or the example embodiments of FIGS. 10 to 32.

The configurations of the example embodiments of FIGS. 7 to 9 may be partially or entirely the same as the configurations of the example embodiments of FIGS. 1 to 6 or the example embodiments of FIGS. 10 to 32.

Referring to FIGS. 7 to 9, the electronic device 101 (e.g., the electronic device 101 of FIGS. 2 to 6) may include a waterproofing structure 500 (e.g., the waterproofing structure 500 of FIG. 6). The waterproofing structure 500 may be disposed between the inner surface 3011a of the side wall 3011 (e.g., the inner surface 3011a of FIG. 6) and the speaker 400 (e.g., the speaker 400 of FIG. 6).

According to an embodiment, the waterproofing structure 500 may include a rigid body 510, a first adhesive member 520, a mesh 530, and an elastic member 540.

Hereinafter, for convenience of description, orthogonal coordinate systems are illustrated in FIGS. 7 and 8. The V-axis direction in FIGS. 7 and 8 may be defined as the height direction or thickness direction of the waterproofing structure 500. The H-axis direction in FIGS. 7 and 8 may be defined as the width direction of the waterproofing structure 500. The coordinate system illustrated in FIG. 9 may have substantially the same directions as the coordinate system of FIGS. 2 to 6.

According to an embodiment, the rigid body 510 may include a hard material (e.g., stainless steel).

According to an embodiment, the rigid body 510 may be disposed between the speaker 400 and the inner surface 3011a of the side wall 3011.

According to an embodiment, the rigid body 510 may include a plate 511, a first opening 512, and at least one rib 513.

According to an embodiment, the plate 511 may form the overall body of the rigid body 510. The plate 511 may have an overall loop shape as the first opening 512 is formed.

According to an embodiment, the first opening 512 may be formed through the plate 511. For example, the first opening 512 may include a hole. The first opening 512 may form at least a portion of a sound path or an acoustic path through which sound generated from the speaker 400 is transmitted. The first opening 512 may have an elongated shape corresponding to the speaker hole 3012.

According to an embodiment, the at least one rib 513 may protrude from an inner edge of the plate 511. For example, the at least one rib 513 may protrude or extend from the inner rim of the plate 511, which defines the first opening 512, toward the speaker hole 3012. According to an embodiment, the at least one rib 513 may be formed by bending at least a portion of the plate 511.

According to an embodiment, the at least one rib 513 may include a first rib 5131 and a second rib 5132.

According to an embodiment, the first rib 5131 may protrude from at least a portion of the inner edge of the plate 511 toward the speaker hole. The second rib 5132 may protrude from another portion of the inner edge of the plate 511 toward the speaker hole.

According to an embodiment, the second rib 5132 may face the first rib 5131. The second rib 5132 may be parallel to the first rib 5131.

According to an embodiment, the second rib 5132 may be spaced apart from the first rib 5131. For example, the second rib 5132 may be spaced apart from the first rib 5131 by a first distance d1 (e.g., the distance in the H-axis direction of FIG. 8). For example, the first distance d1 may be defined as the shortest distance between the first rib 5131 and the second rib 5132, but is not limited thereto. For example, the first distance d1 may be defined as the minimum distance between the first rib 5131 and the second rib 5132. For example, the first distance d1 may be defined as the vertical distance between the first rib 5131 and the second rib 5132.

According to an embodiment, the first adhesive member 520 may include an adhesive material. For example, the first adhesive member 520 may include a waterproof tape or a double-sided tape.

According to an embodiment, the first adhesive member 520 may be disposed between the rigid body 510 and the inner surface 3011a of the side wall 3011. The first adhesive member 520 may be disposed on a lower surface of the plate 511 (e.g., the surface oriented in the −V direction in FIGS. 7 and 8). For example, the first adhesive member 520 may be disposed between the lower surface of the plate 511 and the inner surface 3011a of the side wall 3011 and may be configured to bond the waterproofing structure 500 to the inner surface of the side wall.

According to an embodiment, the first adhesive member 520 may include a second opening 522. For example, the second opening 522 may include a hole. The second opening 522 may be positioned to correspond to the first opening 512. For example, the second opening 522 may be aligned with the first opening 512.

According to an embodiment, the first rib 5131 and the second rib 5132 may be disposed to pass through the second opening 522.

According to an embodiment, the inner edge of the first adhesive member 520 may be spaced apart from the first rib 5131 and the second rib 5132. For example, a gap (e.g., the gap 501 of FIG. 8) may be formed between at least a portion of the inner edge of the first adhesive member 520 and the first rib 5131. In addition, a gap may also be formed between another portion of the inner edge of the first adhesive member 520 and the second rib 5132.

According to an embodiment, the elastic member 540 may be disposed between the rigid body 510 and the speaker 400. For example, the elastic member 540 may be disposed between an upper surface of the plate 511 (e.g., the surface oriented in the +V direction in FIGS. 7 and 8) and the speaker 400. The elastic member 540 may be defined and/or referred to as a sealing member.

According to an embodiment, the elastic member 540 may include an elastic material. The elastic member 540 may be elastically deformable. For example, at least a portion of the elastic member 540 may be in close contact with an enclosure 410 of the speaker 400 when the speaker 400 is assembled into the electronic device 101.

According to an embodiment, the elastic member 540 may include an elastically deformable material. For example, the elastic material of the elastic member 540 may include at least one of a synthetic resin material, a polymer material, or a high-molecular material. For example, the elastic material of the elastic member 540 may include at least one of rubber, silicon, and polymer, but is not limited thereto. For example, the elastic member 540 may be in close contact with the enclosure 410 of the speaker 400 and may include various elastically deformable materials.

According to an embodiment, the mesh 530 may be at least partially accommodated in the elastic member 540.

According to an embodiment, the mesh 530 may include a sound mesh made of a breathable material. For example, the mesh 530 may restrict and/or reduce the inflow of foreign substances into the speaker 400. The mesh 530 may form a passage for transmitting sound generated from the speaker 400 to the outside of the electronic device 101.

According to an embodiment, the mesh 530 may be formed by multiple lines crossing each other. For example, the multiple lines (e.g., metal lines) may be arranged in a grid structure. The mesh 530 may include multiple holes formed as multiple lines are arranged in a grid structure. The sizes of the multiple holes may be variously designed and modified according to acoustic performance or dustproof performance.

According to an embodiment, at least a portion 531 of the mesh 530 may be accommodated in the clastic member 540. Another portion 532 of the mesh member 530 may be arranged to be exposed through an opening of the elastic member 540 (e.g., a third opening 5412 of a first elastic portion 541).

According to an embodiment, the elastic member 540 may include a first elastic portion 541 and a second elastic portion 543.

According to an embodiment, the first elastic portion 541 may be configured to accommodate at least a portion 531 of the mesh 530.

According to an embodiment, the first elastic portion 541 may include a third opening 5412. The third opening 5412 may include a hole formed through the first clastic portion 541. The third opening 5412 may be positioned to correspond to the first opening 512 and/or the second opening 522. For example, the third opening 5412 may be aligned with the first opening 512 and/or the second opening 522.

According to an embodiment, the other portion 532 of the mesh 530 may be exposed through the third opening 5412. The other portion 532 of the mesh 530 may block and/or restrict the inflow of external foreign substances into the speaker 400.

According to an embodiment, the second elastic portion 543 may be configured to enclose the first elastic portion 541. At least a portion of the second elastic portion 543 may be configured contact the speaker 400.

According to an embodiment, the second elastic portion 543 may include a fourth opening 5432. The fourth opening 5432 may include a hole formed through the second elastic portion 543. The fourth opening 5432 may be positioned to correspond to the third opening 5412. For example, the fourth opening 5432 may be aligned with the third opening 5412.

According to an embodiment, sound generated from the diaphragm of the speaker 400 may be transmitted to the speaker hole 3012 through a conduit 402 formed in the speaker enclosure 410, the openings 512, 522, 5412, and 5432 of the waterproofing structure 500, and the other portion 532 of the mesh 530. The speaker enclosure 410 may form at least a portion of the exterior of the speaker 400. The speaker enclosure 410 may accommodate speaker components or a speaker unit. The speaker enclosure 410 may be defined as an acoustic housing.

According to an embodiment, the second elastic portion 543 may include a first cover portion 5431, a second cover portion 5433, and a protrusion 5434.

According to an embodiment, the first cover portion 5431 may be configured to cover an upper surface of the first elastic portion 541 (e.g., the surface oriented in the +V direction in FIG. 8).

According to an embodiment, the second cover portion 5433 may extend from an outer edge of the first cover portion 5431. The second cover portion 5433 may cover an outer side surface 5413 of the first elastic portion 541.

According to an embodiment, an edge 530a (e.g., an outer edge) of the mesh 530 may be covered by the second cover portion 5433. For example, at least a portion of the edge 530a of the mesh 530 may be exposed through the outer side surface 5413 of the first elastic portion 541. As the edge 530a of the mesh 530 is covered by the second cover portion 5433, the inflow of liquid into the inner space of the electronic device 101 along the edge 530a of the mesh 530 may be blocked and/or reduced.

According to an embodiment, the protrusion 5434 may protrude from the first cover portion 5431. The protrusion 5434 may be in close contact with the speaker enclosure 410. The protrusion 5434 may be elastically deformable while being in close contact with the speaker enclosure 410. Accordingly, the space between the speaker 400 and the waterproofing structure 500 may be sealed, thereby restricting and/or reducing sound leakage from the speaker 400 into the inner space of the electronic device 101.

According to an embodiment, the plate 511 of the rigid body 510 may be disposed on a lower surface of the first elastic portion 541 (e.g., the surface oriented in the −V direction in FIG. 8). The plate 511 may be disposed in a recess that is recessed from the lower surface 541 of the first elastic portion 541.

According to an embodiment, an edge 511a (e.g., an outer edge) of the plate 511 may be covered by at least a portion 5411 of the first elastic portion 541.

According to an embodiment, at least a portion of the plate 511 may be disposed between the first elastic portion 541 and the first adhesive member 520.

According to an embodiment, the side wall 3011 may include an inner surface 3011a and an outer surface 3011b. The inner surface 3011a may face the inner space of the electronic device 101, and the outer surface 3011b may face the outside of the electronic device 101.

According to an embodiment, the inner surface 3011a may be inclined with respect to the outer surface 3011b. For example, the inner surface 3011a may not be parallel to the outer surface 3011b.

According to an embodiment, the speaker hole 3012 may be formed to penetrate from the inner surface 3011a to the outer surface 3011b.

According to an embodiment, the stepped portion 3013 may be formed along the periphery of the speaker hole 3012. For example, the stepped portion 3013 may be formed at the boundary between the inner surface 3011a and the speaker hole 3012. For example, the stepped portion 3013 may be formed at the intersection of the inner surface 3011a and an end portion of the inner circumferential surface of the side wall 3011 that defines the speaker hole 3012. The stepped portion 3013 may be recessed to be stepped from the inner surface 3011a.

According to an embodiment, the first rib 5131 and the second rib 5132 of the rigid body 510 may be disposed in the stepped portion 3013.

According to an embodiment, the first rib 5131 may be disposed on at least a portion 30131 of the stepped portion 3013. The second rib 5132 may be disposed on another portion 30132 of the stepped portion 3013.

According to an embodiment, when the speaker 400 is assembled into the electronic device 101 or when the speaker 400 moves inside the electronic device 101 due to an external impact, force may be applied to the waterproofing structure 500 in a direction in which it slips relative to the inner surface 3011a (e.g., the direction s1 of FIG. 9).

According to an embodiment, when slip occurs relative to the waterproofing structure 500, the first rib 5131 may be engaged with at least a portion 30131 of the stepped portion 3013. Accordingly, the amount or distance by which the waterproofing structure 500 slips may be restricted and/or reduced. As the slip of the waterproofing structure 500 is restricted, the deformation of the mesh 530 or the deformation of the first adhesive member 520 may be restricted and/or prevented.

According to an embodiment, as the first rib 5131 and the second rib 5132 are disposed inside the second opening of the second adhesive member 520 (e.g., the second opening 522 of FIG. 7), the second adhesive member 520 may be covered by the first rib 5131 and the second rib 5132. For example, the second adhesive member 520 may not be visually exposed to a user through the speaker hole 3012.

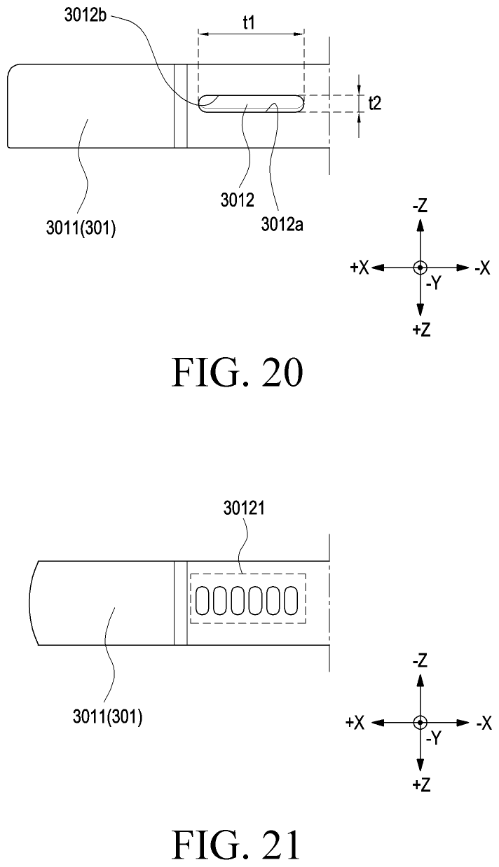

According to an embodiment, the speaker hole 3012 may include a first portion 3012a (e.g., the first portion 3012a of FIG. 20) and a second portion 3012b (e.g., the second portion 3012b of FIG. 20) facing the first portion 3012a. The first portion 3012a and the second portion 3012b may be defined as portions of the inner circumferential surface of the side wall 3011 that defines the speaker hole 3012. A second distance d2 between the first portion 3012a and the second portion 3012b may be defined as the shortest distance between the first portion 3012a and the second portion 3012b, but is not limited thereto. For example, the second distance d2 may be defined as the minimum distance between the first portion 3012a and the second portion 3012b. For example, the second distance d2 may be defined as the vertical distance between the first rib 5131 and the second rib 5132.

According to an embodiment, the first distance d1 between the first rib 5131 and the second rib 5132 may be greater than the second distance d2 between the first portion 3012a and the second portion 3012b. According to an embodiment, the direction of the first distance d1 may differ from the direction of the second distance d2, but is not limited thereto. Depending on the embodiment, the direction of the first distance d1 and the direction of the second distance d2 may be substantially the same.

According to an embodiment, as the first distance d1 between the ribs 5131 and 5132 is formed to be greater than the second distance d2 between the portions 3012a and 3012b, the ribs 5131 and 5132 may not be visually exposed to a user through the speaker hole 3012.

According to an embodiment, the rigid body 510 may be painted black. As the rigid body 510 is painted black, the visual identification of the rigid body 510 from the inside of the speaker hole 3012 may be restricted and/or reduced.

According to an embodiment, the rigid body 510 may have substantially the same color as the side wall 3011. As the rigid body 510 has substantially the same color as the side wall 3011, the visual identification of the rigid body 510 from the inside of the speaker hole 3012 may be restricted and/or reduced.

According to an embodiment, the mesh 530 may be at least partially accommodated and fixed in the elastic member 540. As a result, the waterproofing structure 500 may not require a separate tape for fixing the mesh 530 to the elastic member 540, and the overall thickness of the waterproofing structure 500 (e.g., the thickness in the V-axis direction of FIG. 8) may be reduced.

FIGS. 10, 11, 12, 13, 14, 15, and 16 are diagrams illustrating various views of a manufacturing process of a waterproofing structure according to an embodiment.

The example embodiments of FIGS. 10 to 16 may be combined with the example embodiments of FIGS. 1 to 9 or the example embodiments of FIGS. 17 to 32.

The configurations of the example embodiments of FIGS. 10 to 16 may be partially or entirely the same as the configurations of the example embodiments of FIGS. 1 to 9 or the example embodiments of FIGS. 17 to 32.

Referring to FIG. 10, a manufacturing process of a waterproofing structure (e.g., the waterproofing structure 500 of FIG. 6) may include a process 21 of aligning multiple rigid bodies 51001 on a lower mold plate 11.

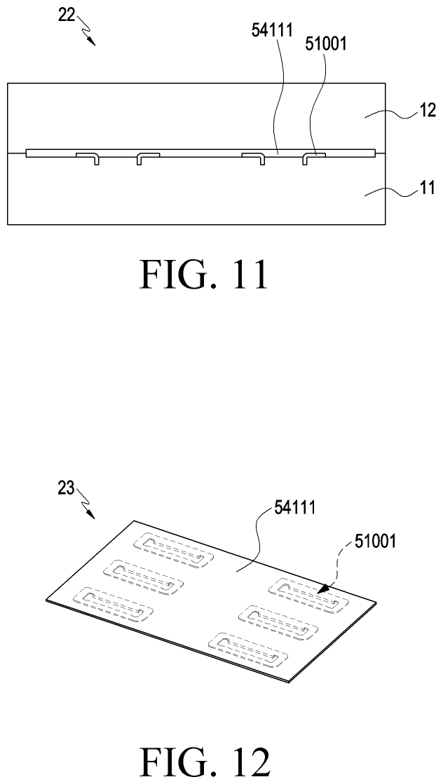

Referring to FIG. 11, the manufacturing process of the waterproofing structure may include covering the multiple rigid bodies 51001 aligned on the lower mold plate 11 with an upper mold plate 12 and then injecting a first rubber layer 54111 into the rigid bodies 51001 (process 22). For example, the rigid bodies 51001 and the first rubber layer 54111 may be insert-molded.

Referring to FIG. 12, the manufacturing process of the waterproofing structure may include separating the lower mold plate 11 and the upper mold plate 12 from the insert-molded rigid bodies 51001 and the first rubber layer 54111 (process 23).

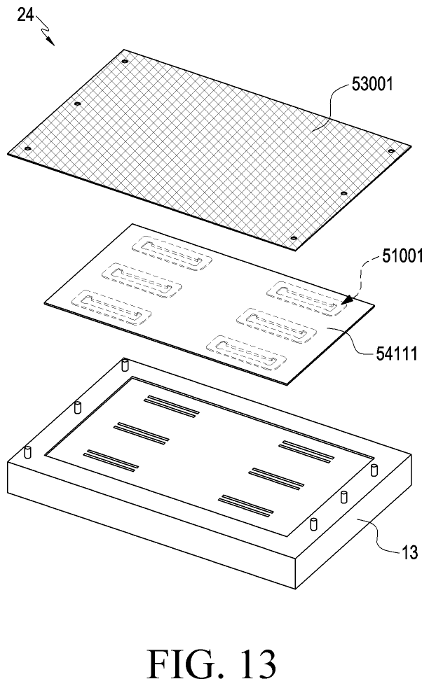

Referring to FIG. 13, the manufacturing process of the waterproofing structure may include aligning the insert-molded rigid bodies 51001 and the first rubber layer 54111 on a lower mold plate 13 and covering the insert-molded rigid bodies with a large-area mesh 53001 (process 24).

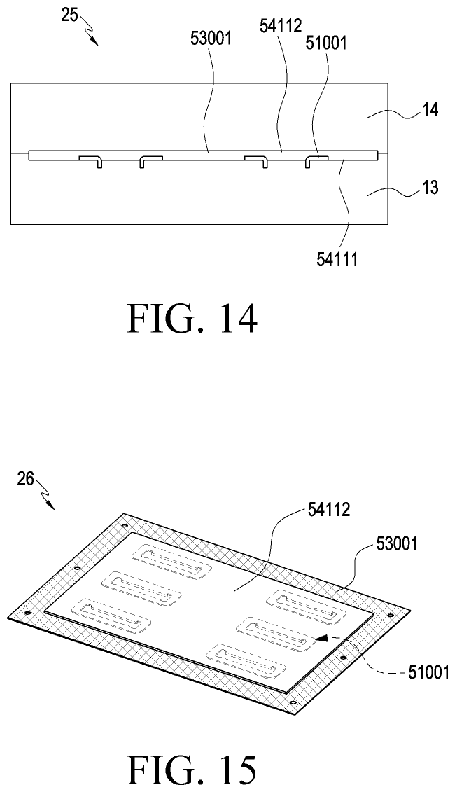

Referring to FIG. 14, the manufacturing process of the waterproofing structure may include covering the first rubber layer 54111 with the large-area mesh 53001, covering the mesh 53001 with an upper mold plate 14, and then injecting a second rubber layer 54112 into the mesh 53001 (process 25). For example, the mesh 53001 and the second rubber layer 54112 may be insert-molded.

Referring to FIG. 15, the manufacturing process of the waterproofing structure may include separating the lower mold plate 13 and the upper mold plate 14 from the insert-molded mesh 53001 and second rubber layer 54112 (process 26).

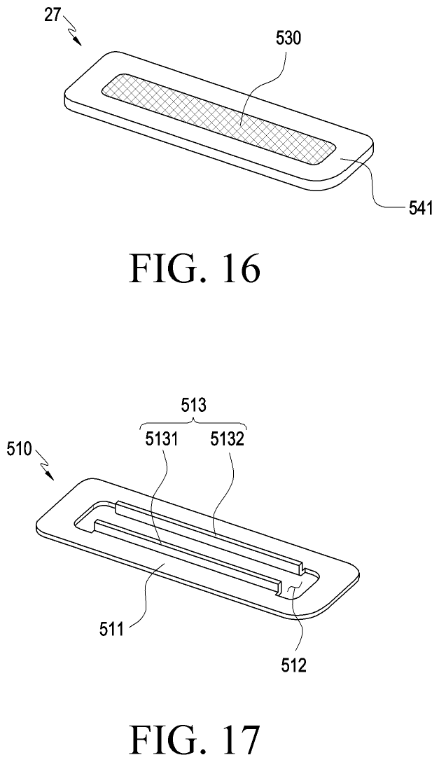

Referring to FIG. 16, the manufacturing process of the waterproofing structure may include forming multiple components using a cutting jig on the molded product (process 27). The multiple components may each include a mesh 530 (e.g., the mesh 530 of FIG. 7), a first elastic portion 541 (e.g., the first elastic portion 541 of FIG. 7), and a rigid body 510 (e.g., the rigid body 510 of FIG. 7), but are not limited thereto. For example, in a state in which the first rubber layer 54111 and the second rubber layer 54112 laminated together, a third opening (e.g., the third opening 5412 of FIG. 7) may be formed using a cutting jig, and the outer side surface of the first elastic portion 541 and the edge of the mesh 530 (e.g., the edge 530a of FIG. 7) may be cut together using the cutting jig. As a result, the first elastic portion 541 and the mesh 530 may form a single component.

Although not illustrated, when a second elastic portion (e.g., the second elastic portion 543 of FIG. 7) is injected into the above component, the waterproofing structure 500 illustrated in FIG. 8 may be manufactured.

FIGS. 17, 18, and 19 are diagrams illustrating perspective views of a rigid body according to an embodiment.

The example embodiments of FIGS. 17 to 19 may be combined with the example embodiments of FIGS. 1 to 16 or the example embodiments of FIGS. 20 to 32.

The configurations of the example embodiments of FIGS. 17 to 19 may be partially or entirely the same as the configurations of the example embodiments of FIGS. 1 to 16 or the example embodiments of FIGS. 20 to 32.

Referring to FIGS. 17 to 19, a rigid body 510 (e.g., the rigid body 510 of FIGS. 7 and 8) may include a plate 511 (e.g., the plate 511 of FIGS. 7 and 8), a first opening 512 (e.g., the first opening 512 of FIGS. 7 and 8), and at least one rib 513 (e.g., the at least one rib 513 of FIGS. 7 and 8). The at least one rib 513 may protrude from an inner edge or an inner rim of the plate 511.

Referring to FIG. 17, the at least one rib 513 may include a first rib 5131 and a second rib 5132.

According to an embodiment, the first rib 5131 may face the second rib 5132. The first rib 5131 may be parallel to the second rib 5132. The first rib 5131 may face the second rib 5132.

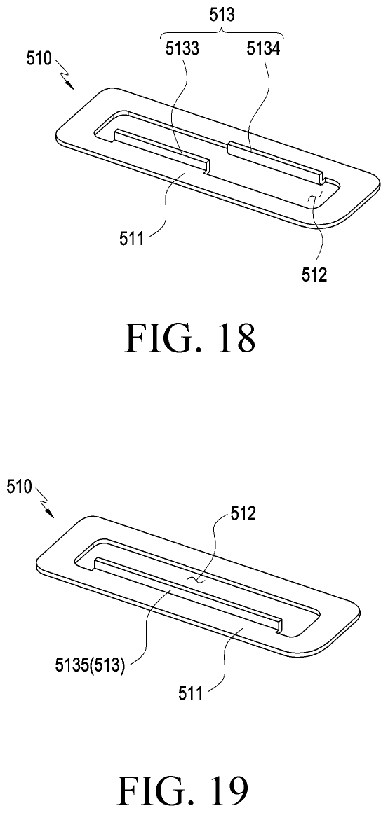

Referring to FIG. 18, the at least one rib 513 may include a first rib 5133 and a second rib 5134.

According to an embodiment, the first rib 5133 may face the second rib 5134. The first rib 5133 may be parallel to the second rib 5134. The first rib 5133 may not face the second rib 5134. For example, the first rib 5133 may be arranged to be offset from the second rib 5134.

Referring to FIG. 19, the at least one rib 513 may include a single rib 5135.

FIG. 20 is a diagram illustrating a plan view of a speaker hole according to an embodiment.

FIG. 21 is a diagram illustrating a plan view of a speaker hole according to an embodiment.

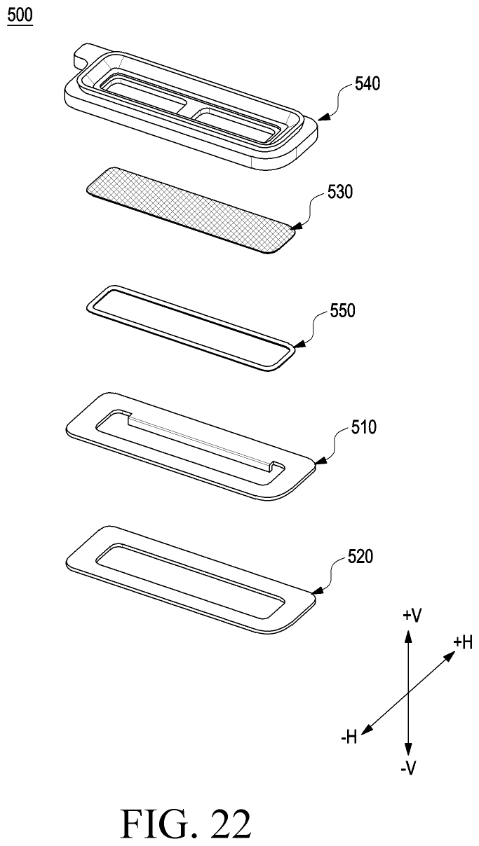

The example embodiments of FIGS. 20 and 21 may be combined with the example embodiments of FIGS. 1 to 19 or the example embodiments of FIGS. 22 to 32.

The configurations of the example embodiments of FIGS. 20 and 21 may be partially or entirely the same as the configurations of the example embodiments of FIGS. 1 to 19 or the example embodiments of FIGS. 22 to 32.

Referring to FIGS. 20 and 21, a housing 301 (e.g., the housing 301 of FIG. 6) may include a side wall 3011 (e.g., the side wall 3011 of FIG. 6) and at least one speaker hole 3012 or 30121 (e.g., the speaker hole 3012 of FIG. 6) formed in the side wall 3011.

Referring to FIG. 20, the speaker hole 3012 may be a single hole, but is not limited thereto. When an outer surface (e.g., the outer surface 3011b of FIG. 9) of the side wall 3011 is viewed (e.g., when the surface oriented in the −Y direction in FIG. 20 is viewed), the speaker hole 3012 may have an elongated shape.

According to an embodiment, the speaker hole 3012 may include a first portion 3012a and a second portion 3012b facing the first portion 3012a.

According to an embodiment, the width t1 of the speaker hole 3012 (e.g., the width in the X-axis direction of FIG. 20) may be greater than the height t2 of the speaker hole 3012 (e.g., the height in the Y-axis direction of FIG. 20).

According to an embodiment, the speaker hole 3012 may be aligned with a waterproofing structure (e.g., the waterproofing structure 500 of FIG. 6) disposed inside the housing 301.

Referring to FIG. 21, the speaker hole 30121 may include multiple speaker holes 30121, but is not limited thereto.

According to an embodiment, the speaker holes 30121 may be aligned with a waterproofing structure (e.g., the waterproofing structure 500 of FIG. 6) disposed inside the housing 301.

FIG. 22 is an exploded perspective view of the waterproofing structure according to an embodiment.

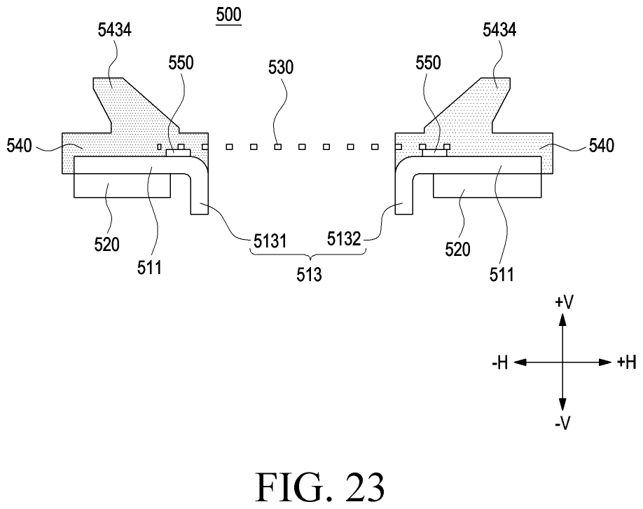

FIG. 23 is a cross-sectional view of the waterproofing structure according to in an assembled state according to an embodiment.

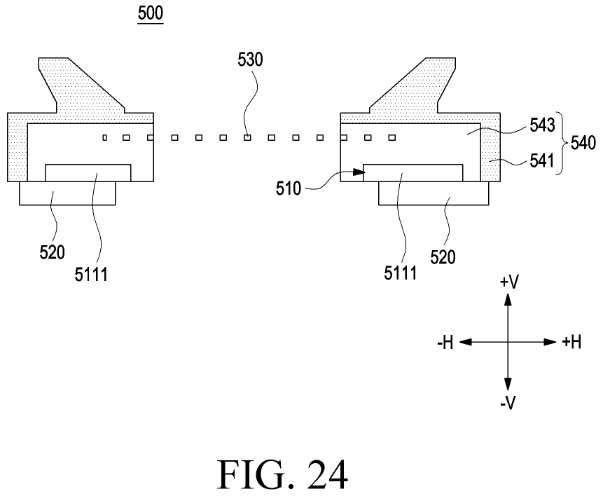

The example embodiments of FIGS. 22 and 23 may be combined with the example embodiments of FIGS. 1 to 21 or the example embodiments of FIGS. 24 to 32.

The configurations of the example embodiments of FIGS. 22 and 23 may be partially or entirely the same as the configurations of the example embodiments of FIGS. 1 to 21 or the example embodiments of FIGS. 24 to 32.

Referring to FIGS. 22 and 23, a waterproofing structure 500 (e.g., the waterproofing structure 500 of FIGS. 6 to 9) may include a rigid body 510, a first adhesive member 520, a mesh 530, an elastic member 540, and a second adhesive member 550. The rigid body 510 may include a plate 511. The rigid body 510 may include at least one rib 513, which includes a first rib 5131 and a second rib 5132.

According to an embodiment, the elastic member 540 may be integrally formed. The elastic member 540 may include a protrusion 5434.

According to an embodiment, the second adhesive member 550 may include an adhesive material. For example, the second adhesive member 550 may include a double-sided tape or a bond.

According to an embodiment, the second adhesive member 550 may be accommodated in the elastic member 540. The second adhesive member 550 may be disposed between the mesh 530 and the plate 511.

According to an embodiment, the second adhesive member 550 may be configured to fix the mesh 530 and the plate 511 to each other.

FIG. 24 is a cross-sectional view of the waterproofing structure in an assembled state according to an embodiment.

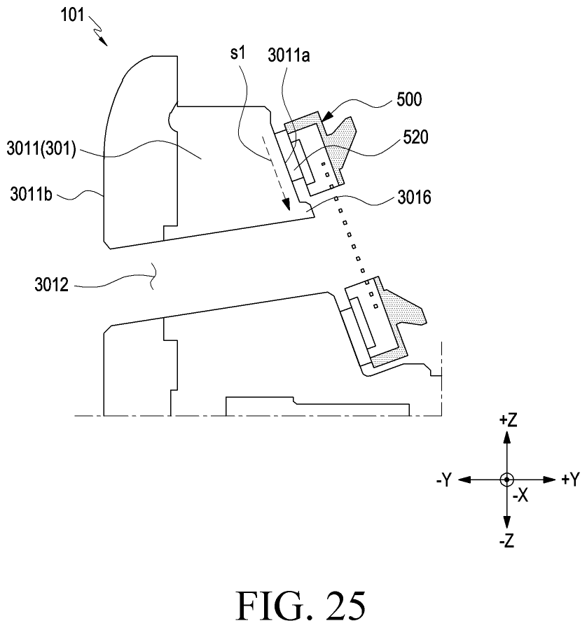

FIG. 25 is a cross-sectional view of an electronic device according to an embodiment.

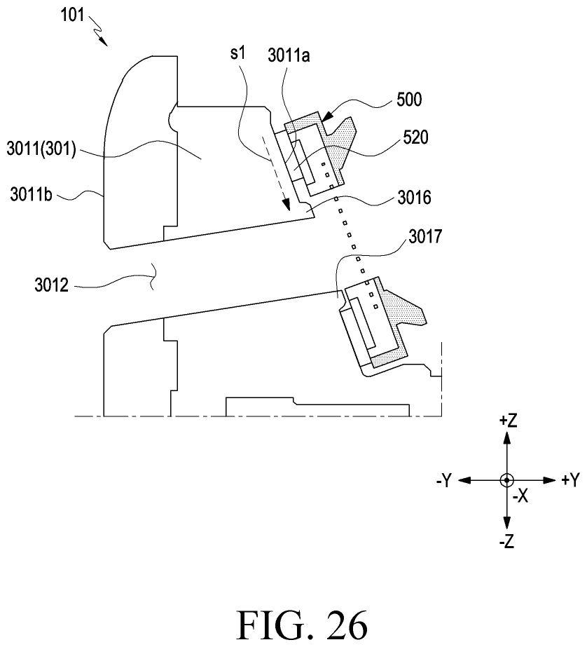

FIG. 26 is a cross-sectional view of an electronic device according to an embodiment.

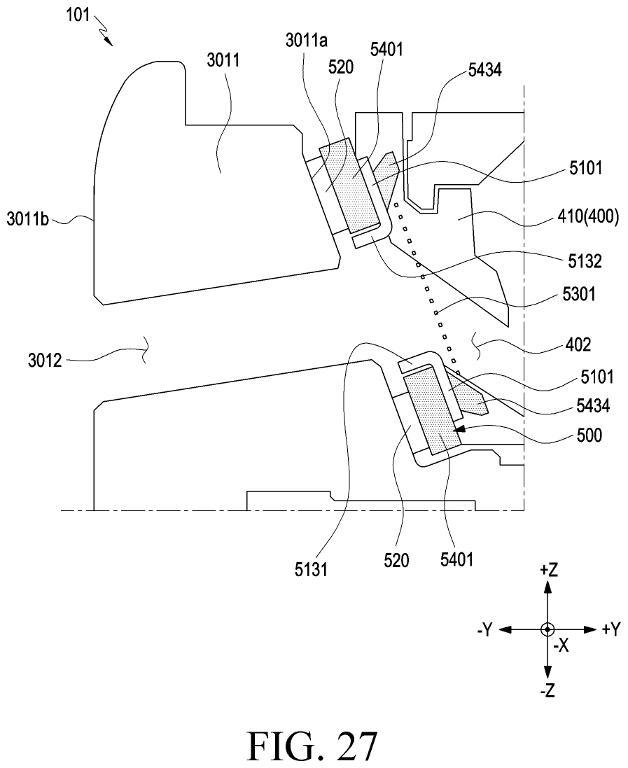

The example embodiments of FIGS. 24 to 26 may be combined with the example embodiments of FIGS. 1 to 23 or the example embodiments of FIGS. 27 to 32.

The configurations of the example embodiments of FIGS. 24 to 26 may be partially or entirely the same as the configurations of the example embodiments of FIGS. 1 to 23 or the example embodiments of FIGS. 27 to 32.

Referring to FIGS. 24 to 26, a waterproofing structure 500 (e.g., the waterproofing structure 500 of FIGS. 6 to 9) may include a rigid body 510, a first adhesive member 520, a mesh 530, and an elastic member 540. The elastic member 540 may include a first elastic portion 541 and a second elastic portion 543.

Referring to FIG. 24, the rigid body 510 may include a plate 5111. The rigid body 510 may not include the at least one rib.

According to an embodiment, as the rigid body 510 does not include the at least one rib, the design freedom regarding the size of the first adhesive member 520 may be increased.

Referring to FIGS. 25 and 26, a housing 301 (e.g., the housing 301 of FIG. 9) may include a side wall 3011 that includes an inner surface 3011a and an outer surface 3011b, and a speaker hole 3012 formed in the side wall 3011.

Referring to FIG. 25, the housing 301 may include at least one protruding portion 3016 that protrudes from the inner surface 3011a. The at least one protruding portion 3016 may protrude from the boundary between the inner surface 3011a and the inner circumferential surface of the speaker hole 3012. The at least one protruding portion 3016 may restrict and/or reduce the amount of slip of the first adhesive member 520 when slip occurs in the waterproofing structure 500 in a sliding direction s1. Accordingly, the deformation of the waterproofing structure 500 may be restricted and/or prevented.

According to an embodiment, the at least one protruding portion 3016 may extend along the width direction of the electronic device 101 (e.g., the X-axis direction of FIG. 25).

Referring to FIG. 26, the housing 301 may include protruding portions 3016 and 3017 that protrude from the inner surface 3011a. The protruding portions 3016 and 3017 may protrude from the boundary between the inner surface 3011a and the inner circumferential surface of the speaker hole 3012. One of the protruding portions 3016 and 3017 (e.g., the protruding portion 3016) may restrict and/or reduce the amount of slip of the first adhesive member 520 when slip occurs in the waterproofing structure 500 in the sliding direction s1. Accordingly, the deformation of the waterproofing structure 500 may be restricted and/or prevented. The protruding portions 3016 and 3017 may be disposed in a second opening (e.g., the second opening 522 of FIG. 7) of the first adhesive member 520 and may restrict visual exposure of the first adhesive member 520 through the speaker hole 3012. The protruding portions 3016 and 3017 may include multiple protruding portions, but are not limited thereto. For example, the housing 301 may include a single loop-shaped protruding portion formed along the periphery of the speaker hole 3012.

FIG. 27 is a cross-sectional view of an electronic device according to an embodiment.

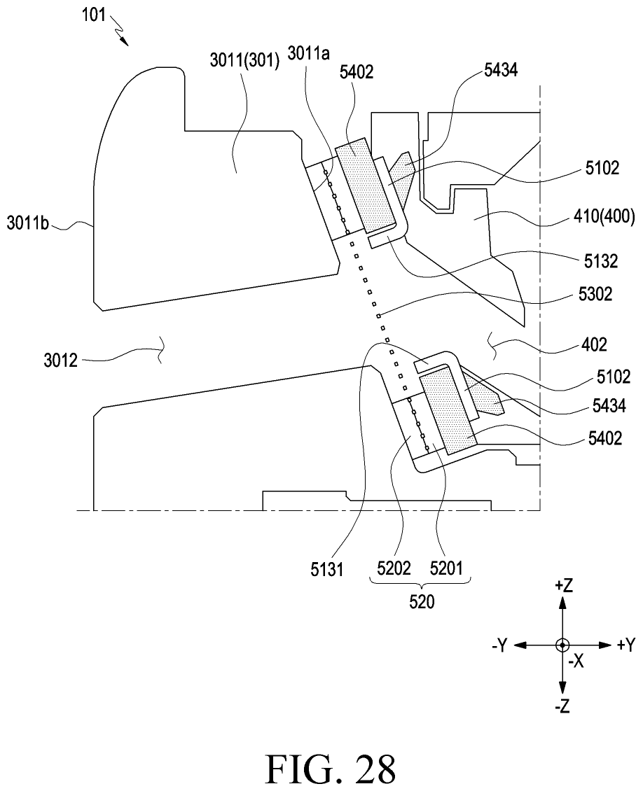

FIG. 28 is a cross-sectional view of an electronic device according to an embodiment.

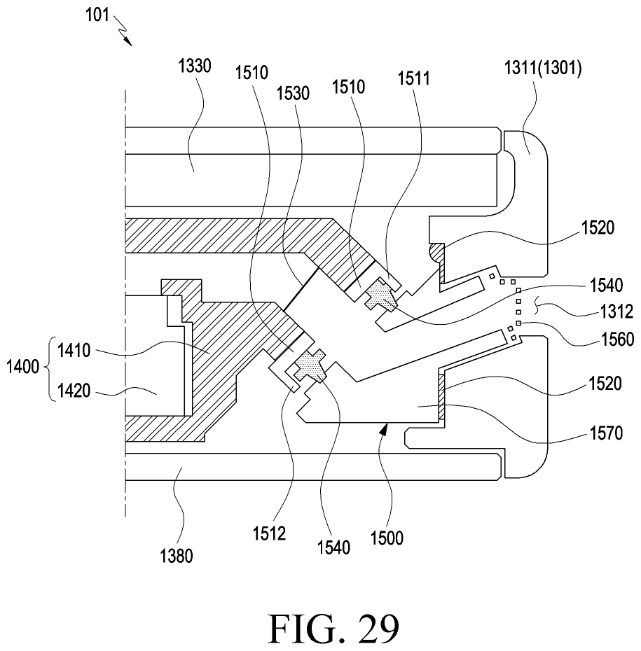

The example embodiments of FIGS. 27 and 28 may be combined with the example embodiments of FIGS. 1 to 26 or the example embodiments of FIGS. 29 to 32.

The configurations of the example embodiments of FIGS. 27 and 28 may be partially or entirely the same as the configurations of the example embodiments of FIGS. 1 to 26 or the example embodiments of FIGS. 29 to 32.

Referring to FIGS. 27 and 28, an electronic device 101 (e.g., the electronic device 101 of FIGS. 6 and 9) may include a housing 301 (e.g., the housing 301 of FIGS. 6 and 9), a waterproofing structure 500 (e.g., the waterproofing structure 500 of FIGS. 6 to 9), and a speaker 400 (e.g., the speaker 400 of FIGS. 6 and 9).

According to an embodiment, the waterproofing structure 500 may include rigid bodies 5101 and 5102 (e.g., the rigid body 510 of FIGS. 7 to 9), a first adhesive member 520, meshes 5301 and 5302 (e.g., the mesh 530 of FIGS. 7 to 9), and elastic members 5401 and 5402 (e.g., the elastic member 540 of FIGS. 7 to 9).

According to an embodiment, the elastic members 5401 and 5402 may each include a protrusion 5434 (e.g., the protrusion 5434 of FIG. 8) that is in close contact with the speaker enclosure 410.

Referring to FIG. 27, the rigid body 5101 and the mesh 5301 may be insert-molded into the speaker enclosure 410. According to an embodiment, when slip occurs in the waterproofing structure 500, the speaker enclosure 410 may restrict and/or reduce the slipping of the waterproofing structure 500 relative to the inner surface 3011a of the side wall 3011. For example, as the rigid body 5102 is fixed to the speaker enclosure 410, ribs 5131 and 5132 of the rigid body 5102 (e.g., the ribs 5131 and 5132 of FIGS. 7 and 8) may restrict the slip of the waterproofing structure 500.

Referring to FIG. 28, the rigid body 5102 may be insert-molded into the speaker enclosure 410. According to an embodiment, when slip occurs in the waterproofing structure 500, the speaker enclosure 410 may restrict and/or reduce the slipping of the waterproofing structure 500 relative to the inner surface 3011a of the side wall 3011. For example, as the rigid body 5102 is fixed to the speaker enclosure 410, ribs 5131 and 5132 of the rigid body 5102 (e.g., the ribs 5131 and 5132 of FIGS. 7 and 8) may restrict the slip of the waterproofing structure 500.

According to an embodiment, the first adhesive member 520 may include a first adhesive portion 5201 and a second adhesive portion 5202.

According to an embodiment, the first adhesive portion 5201 may be disposed between the mesh 5302 and the elastic member 5402. According to an embodiment, the second adhesive portion 5202 may be disposed between the mesh 5302 and the inner surface 3011a.

According to an embodiment, the mesh 5302 may be disposed between the first adhesive portion 5201 and the second adhesive portion 5202.

FIG. 29 is a cross-sectional view of an electronic device according to an embodiment.

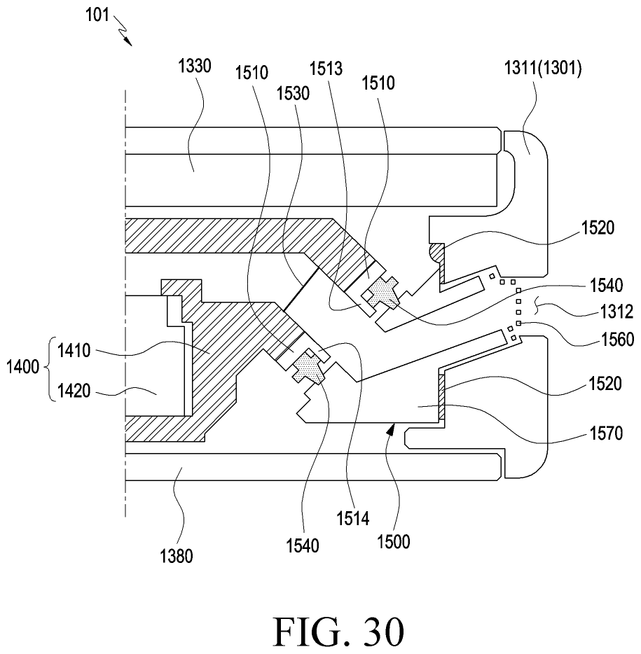

FIG. 30 is a cross-sectional view of an electronic device according to an embodiment.

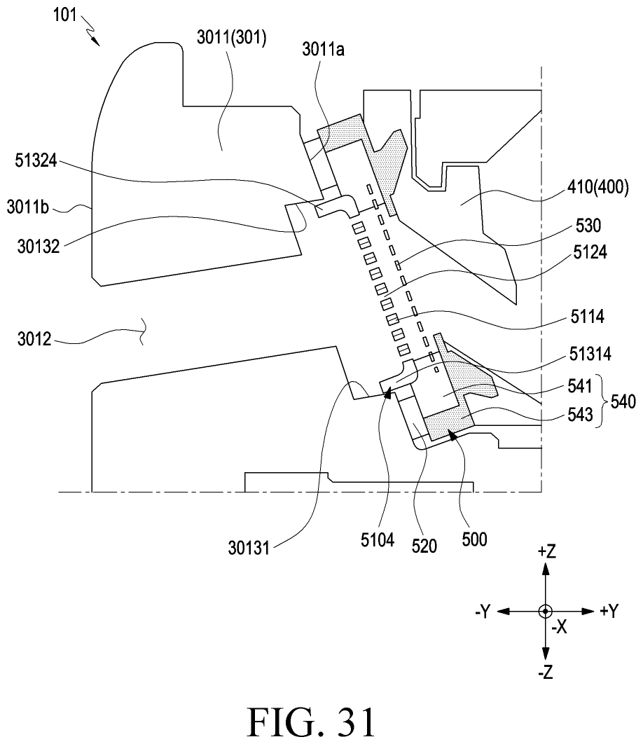

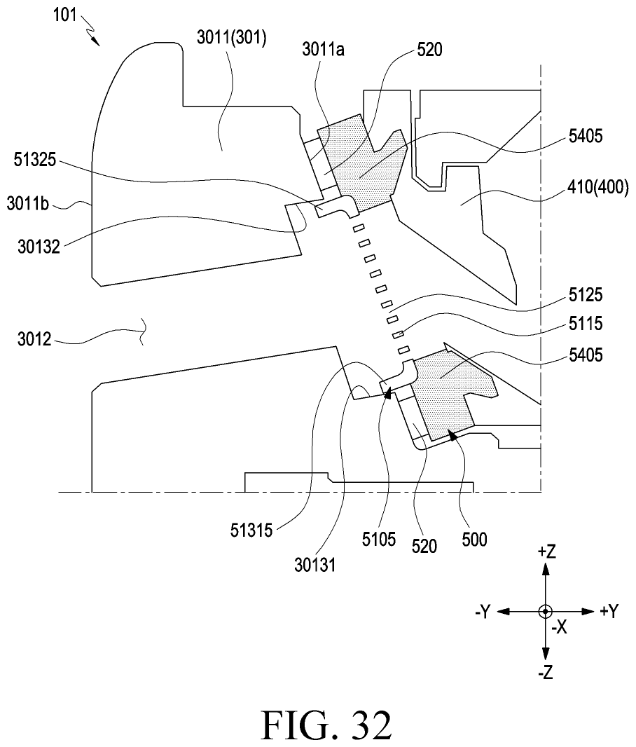

The example embodiments of FIGS. 29 and 30 may be combined with the example embodiments of FIGS. 1 to 28 or the example embodiments of FIGS. 31 to 32.

The configurations of the example embodiments of FIGS. 29 and 30 may be partially or entirely the same as the configurations of the example embodiments of FIGS. 1 to 28 or the example embodiments of FIGS. 31 to 32.

Referring to FIGS. 29 and 30, an electronic device 101 (e.g., the electronic device 101 of FIGS. 2 to 6) may include a housing 1301 (e.g., the housing 301 of FIGS. 4 to 6) that includes a side wall 1311 (e.g., the side wall 3011 of FIGS. 4 to 6).

According to an embodiment, the electronic device 101 may include a display 1330 (e.g., the display 330 of FIGS. 4 and 5), a rear surface plate 1380 (e.g., the rear surface plate 380 of FIGS. 4 and 5), a speaker 1400 (e.g., the speaker 390 of FIGS. 4 and 5 or the speaker 400 of FIG. 6), or a waterproofing structure 1500 (e.g., the waterproofing structure 500 of FIG. 6).

According to an embodiment, the speaker 1400 may include a speaker enclosure 1410 and a speaker component 1420 accommodated in the speaker enclosure 1410.

According to an embodiment, the waterproofing structure 1500 may include a rigid body 1510, a first adhesive member 1520, a first mesh 1530, an elastic member 1540, a second mesh 1560, and a bracket 1570.

According to an embodiment, the second mesh 1560 may be disposed in the speaker hole 1312 and may be configured to block the inflow of foreign substances into the speaker 1400.

According to an embodiment, the bracket 1570 may be adhered to the inner surface of the side wall 1311 through the first adhesive member 1520. The bracket 1570 may form at least a portion of an acoustic path.

According to an embodiment, the elastic member 1540 may be disposed between the rigid body 1510 and the bracket 1570.

According to an embodiment, the first mesh 1530 may be disposed inside the speaker enclosure 1410. The first mesh 1530 may include a membrane configured to block the inflow of liquid into the speaker component 1420.

Referring to FIG. 29, the rigid body 1510 may include a first rib 1511 and a second rib 1512. The first rib 1511 and the second rib 1512 may be configured to cover an outer side surface of the elastic member 1540.

Referring to FIG. 30, the rigid body 1510 may include a first rib 1513 and a second rib 1514. The first rib 1513 and the second rib 1514 may be configured to cover an inner side surface of the elastic member 1540.

FIG. 31 is a cross-sectional view of an electronic device according to an embodiment.

FIG. 32 is a cross-sectional view of an electronic device according to an embodiment.

The example embodiments of FIGS. 31 and 32 may be combined with the example embodiments of FIGS. 1 to 30.

The configurations of the example embodiments of FIGS. 31 and 32 may be partially or entirely the same as the configurations of the example embodiments of FIGS. 1 to 30.

Referring to FIGS. 31 and 32, an electronic device 101 (e.g., the electronic device 101 of FIGS. 2 to 6) may include a housing 301 (e.g., the housing 301 of FIGS. 4 to 6), a waterproofing structure 500 (e.g., the waterproofing structure 500 of FIG. 6), and a speaker 400 (e.g., the speaker 390 of FIGS. 4 and 5 or the speaker 400 of FIG. 6).

According to an embodiment, the waterproofing structure 500 may include rigid bodies 5104 and 5105 (e.g., the rigid bodies 5104 and 5105 of FIGS. 7 to 9) and a first adhesive member 520.

According to an embodiment, the rigid bodies 5104 and 5105 may include plates 5114 and 5115.

According to an embodiment, the rigid bodies 5104 and 5105 may include first ribs 51314 and 51315 and second ribs 51324 and 51325 protruding from the plates 5114 and 5115. The first ribs 51314 and 51315 and the second ribs 51324 and 51325 may be configured to be engaged with stepped portions 30131 and 30132, thereby restricting and/or preventing slip of the waterproofing structure 500.

According to an embodiment, the rigid bodies 5104 and 5105 may include multiple first openings 5124 and 5125 formed in the plates 5114 and 5115. The multiple first openings 5124 and 5125 may be configured to block the inflow of relatively large foreign substances into the speaker 400 from outside the electronic device 101.

Referring to FIG. 31, the waterproofing structure 500 may include a mesh 530 (e.g., the mesh 530 of FIGS. 7 to 9). The size of the multiple first openings 5124 of the rigid body 5104 may be greater than the size of the multiple micro-holes formed in the mesh 530.

According to an embodiment, the waterproofing structure 500 may include an elastic member 540. The elastic member 540 may include a first elastic portion 541 and a second elastic portion 543.

Referring to FIG. 32, the waterproofing structure 500 may not include a mesh. According to an embodiment, the elastic member 5405 may be integrally formed. The elastic member 5405 may be formed through insert molding with the rigid body 5105.

The electronic device may include a speaker for providing sound to a user. The speaker may be disposed inside a housing of the electronic device and may output sound to the outside of the electronic device. A speaker hole may be formed in the housing to output sound generated by the speaker to the outside.

The electronic device may include a waterproofing structure to restrict or prevent the inflow of external foreign substances and/or liquid into the electronic device through the speaker hole.

An embodiment of the disclosure may provide an electronic device capable of restricting and/or reducing the deformation of the waterproofing structure through a waterproofing structure including a rigid body made of a hard material.

According to an embodiment of the disclosure, as the deformation of the mesh or tape of the waterproofing structure is restricted, an electronic device with improved design quality may be provided.

However, the problems intended to be addressed by the disclosure are not limited to those mentioned above and may be variously expanded without departing from the spirit and scope of the disclosure.

An embodiment of the disclosure may provide a waterproofing structure that improves acoustic performance output from the speaker and an electronic device including the same.

According to an embodiment of the disclosure, as slip of the waterproofing structure is restricted, an electronic device with improved rigidity of the waterproofing structure may be provided.

The effects that are capable of being obtained by the disclosure are not limited to those described above, and other effects not described above may be clearly understood by a person ordinarily skilled in the art to which the disclosure belongs based on the following description.

According to an embodiment of the disclosure, an electronic device 101 may include a housing 301 including a side wall 3011 and a speaker hole 3012 formed in the side wall 3011.

According to an embodiment, the electronic device 101 may include a speaker 400 disposed inside the housing 301 and configured to output a sound through the speaker hole 3012.

According to an embodiment, the electronic device 101 may include a waterproofing structure 500 disposed between an inner surface 3011a of the side wall 3011 and the speaker 400.

According to an embodiment, the waterproofing structure 500 may include a rigid body 510 disposed between the speaker 400 and the inner surface 3011a and including a plate 511, a first opening 512 formed in the plate 511, a first rib 5131 protruding from the plate 511, and a second rib 5132 protruding from the plate 511 and spaced apart from the first rib 5131.

According to an embodiment, the waterproofing structure 500 may include a first adhesive member 520 disposed between the rigid body 510 and the inner surface 3011a and including an adhesive material.

According to an embodiment, the waterproofing structure 500 may include an elastic member 540 disposed between the rigid body 510 and the speaker 400 and including an elastic material.

According to an embodiment, the waterproofing structure 500 may include a mesh 530 at least partially accommodated in the elastic member 540.

According to an embodiment, the speaker hole 3012 may include a first portion 3012a and a second portion 3012b facing the first portion 3012a.

According to an embodiment, a first distance between the first rib 5131 and the second rib 5132 may be greater than a second distance between the first portion 3012a and the second portion 3012b.

According to an embodiment, the first adhesive member 520 may include a second opening 522 located to correspond to the first opening 512.

According to an embodiment, the first rib 5131 and the second rib 5132 may be disposed to penetrate the second opening 522.

According to an embodiment, the first rib 5131 and the second rib 5132 may protrude from the plate 511 toward the speaker hole 3012.

According to an embodiment, an inner edge of the first adhesive member 520 may be spaced apart from the first rib 5131 and the second rib 5132.

According to an embodiment, the housing 301 may further include a stepped portion 3013 stepped from the inner surface 3011a of the side wall 3011.

According to an embodiment, the stepped portion 3013 may be formed along a periphery of the speaker hole 3012.

According to an embodiment, the first rib 5131 and the second rib 5132 may be disposed in the stepped portion 3013.

According to an embodiment, the first rib 5131 may be parallel to the second rib 5132.

According to an embodiment, the elastic material may include rubber.

According to an embodiment, the elastic member 540 may include a first elastic portion 541 accommodating at least a portion 531 of the mesh 530.

According to an embodiment, the elastic member 540 may include a second elastic portion 543 surrounding the first elastic portion 541 and configured to contact the speaker 400.

According to an embodiment, the first elastic portion 541 may include a third opening 5412 located to correspond to the first opening 512.

According to an embodiment, another portion 532 of the mesh 530 may be disposed to be exposed through the third opening 5412.

According to an embodiment, at least a portion of the plate 511 may be disposed between the first adhesive member 520 and the first elastic portion 541.

According to an embodiment, an edge 530a of the mesh 530 may be configured to be covered by the second elastic portion 543.

According to an embodiment, the plate 511 may be disposed on a lower surface of the first elastic portion 541.

According to an embodiment, the second elastic portion 543 includes a first cover portion 5431 configured to cover an upper surface of the first elastic portion 541.

According to an embodiment, the second elastic portion 543 may be configured to cover an outer side surface of the first elastic portion 541.

According to an embodiment, when viewing an outer surface 3011b of the side wall 3011, the speaker hole 3012 may have an elongated shape.

According to an embodiment, the inner surface 3011a of the side wall 3011 may be inclined with respect to the outer surface 3011b of the side wall 3011.

According to an embodiment, the waterproofing structure 500 may further include a second adhesive member 550 disposed between the mesh 530 and the plate 511 and including an adhesive material.

According to an embodiment, the second adhesive member 550 may be accommodated in the elastic member 540.

According to an embodiment of the disclosure, an electronic device 101 may include a housing 301 including a side wall 3011 and at least one speaker hole 3012 formed in the side wall 3011.

According to an embodiment, the electronic device 101 may include a speaker 400 disposed inside the housing 301 and configured to output a sound through the speaker hole 3012.

According to an embodiment, the electronic device 101 may include a waterproofing structure 500 disposed between an inner surface 3011a of the side wall 3011 and the speaker 400.

According to an embodiment, the waterproofing structure 500 may include a rigid body 510 disposed between the speaker 400 and the inner surface 3011a and including a plate 511 and at least one first opening 512 formed in the plate 511.

According to an embodiment, the waterproofing structure 500 may include a first adhesive member 520 disposed between the rigid body 510 and the inner surface 3011a and including an adhesive material.

According to an embodiment, the waterproofing structure 500 may include an elastic member 540 disposed between the rigid body 510 and the speaker 400 and including an elastic material.

According to an embodiment, the waterproofing structure 500 may include a mesh 530 at least partially accommodated in the elastic member 540.

According to an embodiment, the rigid body 510 may include at least one rib 513 extending from the plate 511 toward the speaker hole 3012.

According to an embodiment, the housing 301 may include multiple speaker holes 30121.

According to an embodiment, the housing 301 may include at least one protruding portion 3016 or 3017 protruding from the inner surface 3011a toward the waterproofing structure 500.

According to an embodiment, the rigid body 5104 may include multiple first openings 5124.

While the disclosure has been illustrated and described with reference to various example embodiments, it will be understood that the various example embodiments are intended to be illustrative, not limiting. It will be further understood by one skilled in the art that various modifications can be made without departing from the scope of the disclosure, including the appended claims and their equivalents. It will also be understood that any of the embodiment(s) described herein may be used in conjunction with any other embodiment(s) described herein.

What is claimed is:

1. An electronic device comprising:
a housing including a side wall and a speaker hole formed in the side wall;
a speaker disposed inside the housing and configured to output a sound through the speaker hole; and
a waterproofing structure disposed between an inner surface of the side wall and the speaker,
wherein the waterproofing structure includes:
a rigid body disposed between the speaker and the inner surface and including a plate, a first opening formed in the plate, a first rib protruding from the plate, and a second rib protruding from the plate and spaced apart from the first rib;
a first adhesive member disposed between the rigid body and the inner surface and including an adhesive material;
an elastic member disposed between the rigid body and the speaker and including an elastic material; and
a mesh at least partially accommodated in the elastic member,
wherein the speaker hole includes a first portion and a second portion facing the first portion, and
wherein a first distance between the first rib and the second rib is greater than a second distance between the first portion and the second portion.

2. The electronic device of claim 1, wherein the first adhesive member includes a second opening located to correspond to the first opening, and
wherein the first rib and the second rib are disposed to penetrate the second opening.

3. The electronic device of claim 1, wherein the first rib and the second rib protrude from the plate toward the speaker hole.

4. The electronic device of claim 1, wherein an inner edge of the first adhesive member is spaced apart from the first rib and the second rib.

5. The electronic device of claim 1, wherein the housing further includes a stepped portion stepped from the inner surface of the side wall,
wherein the stepped portion is formed along a periphery of the speaker hole, and
wherein the first rib and the second rib are disposed in the stepped portion.

6. The electronic device of claim 1, wherein the first rib is parallel to the second rib.

7. The electronic device of claim 1, wherein the elastic material includes a rubber, and
wherein the elastic member includes a first elastic portion accommodating at least a portion of the mesh and a second elastic portion surrounding the elastic portion and configured to contact the speaker.

8. The electronic device of claim 1, wherein the first elastic portion includes a third opening located to correspond to the first opening, and
wherein another portion of the mesh is disposed to be exposed through the third opening.

9. The electronic device of claim 1, wherein at least a portion of the plate is disposed between the first adhesive member and the first elastic portion.

10. The electronic device of claim 1, wherein an edge of the mesh is covered by the second elastic portion.

11. The electronic device of claim 1, wherein the plate is disposed on a lower surface of the first elastic portion, and
wherein the second elastic portion includes a first cover portion configured to cover an upper surface of the first elastic portion and a second cover portion configured to cover an outer side surface of the first elastic portion.

12. The electronic device of claim 1, wherein when viewing an outer surface of the side wall, the speaker hole has an elongated shape.

13. The electronic device of claim 1, wherein the inner surface of the side wall is inclined with respect to the outer surface of the side wall.

14. The electronic device of claim 1, wherein the waterproofing structure further includes a second adhesive member disposed between the mesh and the plate and including an adhesive.

15. The electronic device of claim 14, wherein the second adhesive member is accommodated in the elastic member.

16. An electronic device comprising:
a housing including a side wall and at least one speaker hole formed in the side wall;
a speaker disposed inside the housing and configured to output a sound through the speaker hole; and
a waterproofing structure disposed between an inner surface of the side wall and the speaker,
wherein the waterproofing structure includes:
a rigid body disposed between the speaker and the inner surface, the rigid body including a plate and at least one first opening formed in the plate;
a first adhesive member disposed between the rigid body and the inner surface and including an adhesive material;
an elastic member disposed between the rigid body and the speaker and including an elastic material; and
a mesh at least partially accommodated in the elastic member.

17. The electronic device of claim 16, wherein the rigid body includes at least one rib extending from the plate toward the speaker hole.

18. The electronic device of claim 16, wherein the housing includes multiple speaker holes.

19. The electronic device of claim 16, wherein the housing includes at least one protruding portion protruding from the inner surface toward the waterproofing structure.

20. The electronic device of claim 16, wherein the rigid body includes multiple first openings.
